(19) United States
(12) Patent Application Publication
(10) Pub. No.: US 2019/0317419 A1
(43) Pub. Date: Oct. 17, 2019

(54) ELECTROPHOTOGRAPHIC IMAGE FORMING METHOD

(71) Applicant: Konica Minolta, Inc., Tokyo (JP)

(72) Inventor: Kazuhiko NAKAJIMA, Tokyo (JP)

(21) Appl. No.: 16/299,858

(22) Filed: Mar. 12, 2019

(30) Foreign Application Priority Data
Apr. 12, 2018 (JP) 2018-076910

(51) Int. Cl. G03G 9/09; G03G 9/097; G03G 9/087; G03G 15/01; G03G 15/20

(52) U.S. Cl. CPC G03G 9/09; G03G 9/0902; G03G 9/09733; G03G 15/2025; G03G 9/08711; G03G 15/0105; G03G 9/08755

(57) ABSTRACT

Provided is an electrophotographic image forming method using two or more electrostatic image developing toners including a charging step, an exposing step, a developing step, a transferring step, and a fixing step, wherein, among the two or more toners, at least one is an achromatic color toner or a clear toner, and at least one is a chromatic color toner which contains a crystalline resin and a releasing agent; in the fixing step, a recording material to which is transferred an unfixed image formed with the two or more electrostatic image developing toners is nipped and conveyed to a fixing nip portion provided between a heated fixing rotating body and a pressure member, and thermally fixed; and a residual toner component is cleaned by a cleaning rotating body which is in contact with the fixing rotating body and a cleaning member which is in contact with the cleaning rotating body.

Japanese Patent Application No. 2018-076910, filed on Apr. 12, 2018 with Japan Patent Office, is incorporated herein by reference in its entirety.

### TECHNICAL FIELD

The present invention relates to an electrophotographic image forming method. More specifically, the present invention relates to an electrophotographic image forming method which enables to achieve small gloss unevenness and small image density unevenness, and is capable of suppressing toner contamination and having high paper feeding property.

### BACKGROUND

In recent years, in the electrophotographic image forming method, as a market trend, there is a movement to actively adopt achromatic toner in order to give further high added value to the electrophotographic image. For example, one proposal is to be able to print a white toner (also referred to as “white color toner”) as a base in order to enable color printing on colored paper. Other proposal is to print a clear toner on the outermost surface of the image for gloss unevenness control or scratch resistance propensity. Another proposal is to use a black toner and a gray toner together to reproduce the smoother gray gradation.

However, in the prior art, while maintaining the color reproduction areas of yellow (Y), magenta (M), cyan (C), and black (K) (without lowering the upper limit of the toner adhesion amount of Y, M, C, and K), when an achromatic toner such as a white toner is used, the total amount of the toner adhesion amount (amount of used toner per unit area) increases, and as a result, there is a problem that the residual toner increases on the fixing roller. In order to solve this problem, it was attempted to cope with this problem by simply cleaning with a conventional cleaning rotating body without using a special cleaning member (for example, a cleaning web). With this conventional technique alone, as a result of an increase in the adhesion amount, it was impossible to answer the strict demand for mixed color contamination (a color contamination) of a achromatic toner in the market (see, for example, Patent Document 1: JP-A 2015-94784). In addition, because of the increased color toner, deterioration of fixability was also caused. This problem is an entirely new problem that has occurred in recent years in order to create a higher value added product using an achromatic color toner image.

### SUMMARY

The present invention has been made in view of the above problems and circumstances. An object of the present invention is to provide an electrophotographic image forming method that achieves compatibility between prevention of color contamination of an image formed using an achromatic color image such as white or gray, or an image formed using a transparent clear toner and low-temperature fixability.

In order to solve the above problems, the inventors of the present invention have examined the causes of the above-mentioned problems and found the following. By using a toner containing a crystalline resin, and using a specific fixing device provided with a cleaning rotating member in contact with the fixing rotating member in the fixing step and a cleaning member in contact with the cleaning rotating member, it is possible to achieve compatibility between prevention of color contamination of an image formed using an achromatic color image such as white or gray, or an image formed using a transparent clear toner and low-temperature fixability. Thus the present invention has been achieved. That is, the problem according to the present invention is solved by the following means.

An electrophotographic image forming method reflecting an aspect of the present invention is an electrophotographic image forming method using two or more electrostatic image developing toners comprising a charging step, an exposing step, a developing step, a transferring step, and a fixing step,

wherein, among the two or more electrostatic image developing toners, at least one is an achromatic color toner or a clear toner, and at least one is a chromatic color toner which contains a crystalline resin and a releasing agent;

in the fixing step, a recording material to which is transferred an unfixed image formed with the two or more electrostatic image developing toners is nipped and conveyed to a fixing nip portion provided between a heated fixing rotating body and a pressure member, and thermally fixed; and

in the fixing step, a residual toner component is cleaned by a cleaning rotating body which is in contact with the fixing rotating body and a cleaning member which is in contact with the cleaning rotating body.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a schematic diagram illustrating a configuration of an image forming apparatus.

FIG. 2 is a schematic cross-sectional view for explaining an example of a fixing device.

FIG. 3 is a schematic cross-sectional view for explaining another example of a fixing device.

### DETAILED DESCRIPTION OF THE EMBODIMENTS

Hereinafter, one or more embodiments of the present invention will be described with reference to the drawings. However, the scope of the invention is not limited to the disclosed embodiments.

According to the present invention, it is possible to provide an electrophotographic image forming method that is compatible with mixed color contamination prevention and low-temperature fixability for an image formed using an achromatic image such as white or gray or an image formed using a transparent clear toner.

It is presumed that an expression mechanism or an action mechanism of the effect of the present invention is as follows. A toner containing a crystalline resin generally used for imparting low-temperature fixability has one of its disadvantages that it has a sharp melting property with respect to temperature and a viscosity near a fixing temperature changes more than the toner of the amorphous resin. On the other hand, on the surface of the fixing roller, there is so-called “temperature ripple (high or low temperature of a wave form)”. Therefore, in the case of a toner containing a crystalline resin, the degree of adhesion to the surface of the fixing roller increases because the viscosity drops remarkably at the temperature upper limit side (higher temperature ripple side). As a result, it is estimated that the amount of toner remaining on the surface of the fixing roller will increase. Therefore, an increase in the amount of toner remaining on the surface of the fixing roller tends to cause mixed color contamination of the image. In particular, in order to respond to market demands such as further improvement of image quality with high added value and environmental response such as energy saving in image formation, it is considered to be a very difficult task to realize low-temperature fixing by using an achromatic color toner or a clear toner.

However, the present invention has the following features: at least one of two or more kinds of toners used for image formation is an achromatic color toner or clear toner and at least one is a chromatic color toner containing a crystalline resin and a release agent; in the fixing step, a recording material to which is transferred an unfixed image formed with the two or more electrostatic image developing toners is nipped and conveyed to a fixing nip portion provided between a heated fixing rotating body and a pressure member, and thermally fixed; and in the fixing step, a residual toner component is cleaned by a cleaning rotating body which is in contact with the fixing rotating body and a cleaning member which is in contact with the cleaning rotating body. By combining techniques as described above, it is possible to achieve compatibility between mixed color contamination prevention and low-temperature fixability of an achromatic color image such as white or gray or an image formed using a transparent clear toner. It is presumed that an expression mechanism or an action mechanism of this effect is as follows.

Although the crystalline resin has the drawbacks as described above, it has a relatively lower electrical resistance than the amorphous resin, so that electrostatic offset with the fixing rotating body in the vicinity of the fixing nip portion is suppressed. Thereby it is considered that image defects such as color mixing contamination can be avoided. On the other hand, in the fixing step according to the present invention, by using the apparatus having the above-described configuration, it is possible to clean and erase the wax latent image generated by adhesion of the colorant and wax supplied from the toner at the time of fixing and heating onto the surface of the fixing rotating body. It is considered that mixed color contamination of images can be prevented. Further, by providing the cleaning member not on the fixing rotary member but on the cleaning rotary member, it is possible to eliminate contamination of the cleaning rotary member in contact with the fixing rotary member, and the colorant or wax on the fixing rotating body can be appropriately present without involving the latent image formation. As a result, it is inferred that the problem of thin paper winding around may also be solved.

An electrophotographic image forming method of the present invention is a method using two or more electrostatic image developing toners comprising a charging step, an exposing step, a developing step, a transferring step, and a fixing step, wherein, among the two or more electrostatic image developing toners, at least one is an achromatic color toner or a clear toner, and at least one is a chromatic color toner which contains a crystalline resin and a releasing agent;

in the fixing step, a recording material to which is transferred an unfixed image formed with the two or more electrostatic image developing toners is nipped and conveyed to a fixing nip portion provided between a heated fixing rotating body and a pressure member, and thermally fixed; and in the fixing step, a residual toner component is cleaned by a cleaning rotating body which is in contact with the fixing rotating body and a cleaning member which is in contact with the cleaning rotating body. This feature is a technical feature common or corresponding to the following embodiments.

In an embodiment of the present invention, it is preferable that the achromatic color toner is a white toner or a gray toner from the viewpoint of the magnitude of the effect of the present invention.

In addition, it is preferable that the white toner contains titanium oxide as a white colorant from the viewpoint of cost and the like for providing a white density of the same density. Furthermore, it is preferable that the white toner contains titanium oxide in the range of 10 to 70 mass % from the viewpoint of improving the quality of the white image.

In the present invention, from the same viewpoint as above, the titanium oxide is preferably rutile type titanium oxide or anatase type titanium oxide from the viewpoint of the color (hue) of the white image.

Also, from the viewpoint of general practical use, the chromatic color toner is preferably a cyan toner, a magenta toner or a yellow toner. Further, it is preferable that the releasing agent for the chromatic color toner contains an ester wax or a hydrocarbon wax as a main component in order to suppress filming, deterioration of heat resistance of the toner.

In the present invention, it is preferable that the total amount of toner on the recording material at the time of fixing is in the range of 8 to 30 g/m² from the viewpoints of transferability, mixed color contamination and low-temperature fixability.

Further, it is preferable that the cleaning rotating body is a cleaning rotating roller (hereinafter also referred to as a “cleaning roller”).

In addition, it is preferable that the cleaning member is a nonwoven fabric containing at least one of an aromatic polyamide fiber and a polyester fiber. Further, it is preferable that the cleaning member is a nonwoven fabric containing an aromatic polyamide fiber and a polyester fiber, and a mass ratio (PA:PE) of the aromatic polyamide fiber (PA) to the polyester fiber (PE) is in the range of 9:1 to 1:9. This is because it is close to the structure of the toner constituent resin and wax, so that it is possible to reliably collect dirt attributable to the components attached to the cleaning rotating body. It is preferable that the cleaning member is wound up in an amount of 0.1 μm to 1 mm per A4 size paper from the viewpoint of cleaning efficiency, and usage fee of the cleaning member. Furthermore, it is preferable that the cleaning member is not impregnated with a silicone oil for the purpose of preventing image stains. Regarding to the thin paper winding resistance that can be imparted by the silicone oil can be secured by the inclusion of the releasing agent in the toner.

In the present invention, it is preferable that the crystalline resin contains a crystalline polyester resin from the viewpoint of low-temperature fixability. It is further preferable that the crystalline resin contains a hybrid crystalline polyester resin in which a crystalline polyester polymerization segment and an amorphous polymerization segment are chemically bonded to each other so that the dispersed particle diameter of the crystalline resin in the toner is controlled to a desired value.

The present invention and the constitution elements thereof, as well as configurations and embodiments, will be detailed in the following. In the present description, when two figures are used to indicate a range of value before and after “to”, these figures are included in the range as a lowest limit value and an upper limit value.

In addition, in the present invention, a “chromatic color toner” basically means a toner having three attributes of hue, lightness, and saturation, such as yellow toner, magenta toner, and cyan toner. An “achromatic color toner” is basically a toner which has no hue and saturation and has only lightness, such as black toner, white toner (also referred to as a “white color toner”) and gray toner. Here, a white toner designates a toner having a color (white color) satisfying the following: the lightness L* is 80 or more; and a* and b* are −10<a*<10 and −10<b*<10 (white color) in the CIE L*a*b* color space, wherein the measurement is done for the case where only a white toner is transferred onto a transfer material, and its surface is measured with a spectral color difference meter in accordance with JIS Z 8781-4: 2013.

A “clear toner” is a toner in which the layer formed of the clear toner transmits light in almost the entire visible light region or light in a partial region in an electrophotographic image, and achieving a so-called transparency state in which the opposite side of the layer can be seen through. The light transmittance is not particularly limited as long as the transmittance is such that it can be seen through, but it is 50% or more, preferably 70% or more, more preferably 90% or more. In addition, when light in almost the entire visible light region is transmitted, it becomes colorless and transparent.

The term “color toner” as used in the present specification means a toner belonging to a toner group including a chromatic color toner and an achromatic color toner including a black toner and a gray toner. It is assumed that a white toner and a clear toner are not included in the color toner. That is, since most of the recording medium (for example, recording paper) normally used has a white color, this white color is used as a reference color, and the chromatic color toner, the black color and the gray toner which are recognized to be different from this white color will be referred to as a “color toner” for the sake of convenience.

### [Electrophotographic Image Forming Method]

An electrophotographic image forming method of the present invention is a method using two or more electrostatic image developing toners comprising a charging step, an exposing step, a developing step, a transferring step, and a fixing step, wherein, among the two or more electrostatic image developing toners, at least one is an achromatic color toner or a clear toner, and at least one is a chromatic color toner which contains a crystalline resin and a releasing agent,

in the fixing step, a recording material to which is transferred an unfixed image formed with the two or more electrostatic image developing toners is nipped and conveyed to a fixing nip portion provided between a heated fixing rotating body and a pressure member, and thermally fixed,

in the fixing step, a residual toner component is cleaned by a cleaning rotating body which is in contact with the fixing rotating body and a cleaning member which is in contact with the cleaning rotating body.

In the following, a charging step, an exposing step, a developing step, a transferring step, a fixing step, and a fixing-cleaning step included in the fixing step will be described.

### <Charging Step>

In this step, an electrophotographic photoreceptor is charged. A method for charging is not limited in particular. For example, it may be used a known method such as a charge roller method that charges an electrophotographic photoreceptor with a charge roller.

### <Exposing Step>

In this step, an electrostatic latent image is formed on the electrophotographic photoreceptor (an electrostatic latent image carrier). An electrophotographic photoreceptor is not limited in particular. For example, it may be used a drum type photoreceptor composed of an organic photoreceptor such as polysilane and phthalopolymethine.

Formation of an electrostatic latent image is done: by uniformly charging the surface of the electrophotographic photoreceptor in the charging step; and then, by imagewise exposing the surface of the electrophotographic photoreceptor in the exposing step.

An exposing device is not limited in particular. It may be used an exposing device generally used in an electrophotographic method.

### <Developing Step>

A developing step is a process to develop the electrostatic latent image with a dry developer containing the toner according to the present invention to form a toner image.

Formation of the toner image is done by using a dry developer containing the toner. It is done by using a developing device composed of: a stirrer to charge the toner with friction stirring; and a rotatable magnet roller.

Specifically, in the developing device, the toner and the carrier are stirred to be mixed. During that time, the toner is charged by friction. The toner is retained on the surface of the rotating magnet roller to form a magnetic brush. Since the magnet roller is arranged in the vicinity of the electrophotographic photoreceptor (an electrostatic latent image carrier), a part of toner constituting the magnetic brush formed on the surface of the rotating magnet roller is moved to the surface of the photoreceptor by the electric attraction. As a result, the electrostatic latent image is developed by the toner to form a toner image on the surface of the photoreceptor.

### <Transferring Step>

In this step, the toner image is transferred to an image support. Transfer of the toner image to the image support is done by conducting peeling electrification of the image to the image support. As a transferring device, it may be used: a corona transferring device with a corona discharge; a transfer belt; and a transfer roller.

The transferring step may be done by the following.

By using an intermediate transfer member, a toner image is transferred at first to the intermediate transfer member, and then, this toner image is secondly transferred to an image support. Otherwise, it may form an image by directly transferring the toner image formed on the electrophotographic photoreceptor (an electrostatic latent image carrier) to the image support.

The image support is not limited in particular. It may be used a various materials such as: a plain paper from thin paper to thick paper, a high quality paper, a printing paper of an art paper and a coat paper, a commercially available Japanese paper and a post card paper, a plastic film for OHP, and a cloth.

### <Fixing Step>

In the fixing step according to the present invention, the recording material to which the unfixed image formed by using the two or more kinds of toners is transferred and nipped in the fixing nip portion provided between the heated fixing rotating body and the pressure member, and thermally fixed. As a method of the fixing step, a specific example is the following: a roller fixing method which is composed of a fixing rotating roller (also referred to as a “fixing roller”) as a fixing rotating body and a pressure roller as a pressure member that is provided in a state of being pressed to the fixing roller so as to form a fixing nip portion on the fixing roller. Further, a belt fixing method in which the fixing rotating body is constituted by a fixing belt can also be mentioned.

### <Fixing-Cleaning Step>

In the cleaning step included in the fixing step, a residual toner component is cleaned by providing a cleaning rotating body which is in contact with the fixing rotating body and a cleaning member which is in contact with the cleaning rotating body. The cleaning rotating body in contact with the fixing rotating body has a function of removing residual toner components such as releasing agent and wax on the surface of the fixing rotating body. From the viewpoint of more effectively obtaining the effect of the present invention, it is preferable that the cleaning rotating body is a cleaning rotating roller.

In addition, it is preferable that the cleaning member is a nonwoven fabric (also referred to as a “cleaning web”) containing at least one of an aromatic polyamide fiber and a polyester fiber. Since these nonwoven fabrics are close to the structure of the resin and releasing agent constituting the toner particles, dirt attributable to these constituent components adhering to the rotating member can be more reliably collected. Further, it is preferable that the cleaning member is not impregnated with a silicone oil. This is because resistance to winding thin paper that can be imparted by a silicone oil can be secured by the inclusion of a release agent into the toner.

### <Cleaning Step for Developer>

Since there remains the residual developer on the developer carrier such as the developing roller, the photoreceptor, and the intermediate transfer member, which is not used for formation of the image and remained thereon, it is preferable to have a cleaning step for removing the developer from the developer carrier.

A method for removing the developer from the developer carrier is not limited in particular. A preferable method is to use a blade that rubs the surface of the photoreceptor by locating at the position from which the edge portion of the blade abuts the photoreceptor.

### [Image Forming Apparatus]

Hereinafter, an example of a general image forming apparatus using YMCK toner will be described. In the case of using a white toner and a clear toner as well, it differs in that a similar apparatus in which an image forming unit in consideration of this is added is used. Since the basic principle is the same, the explanation in this case is the same as the following explanation.

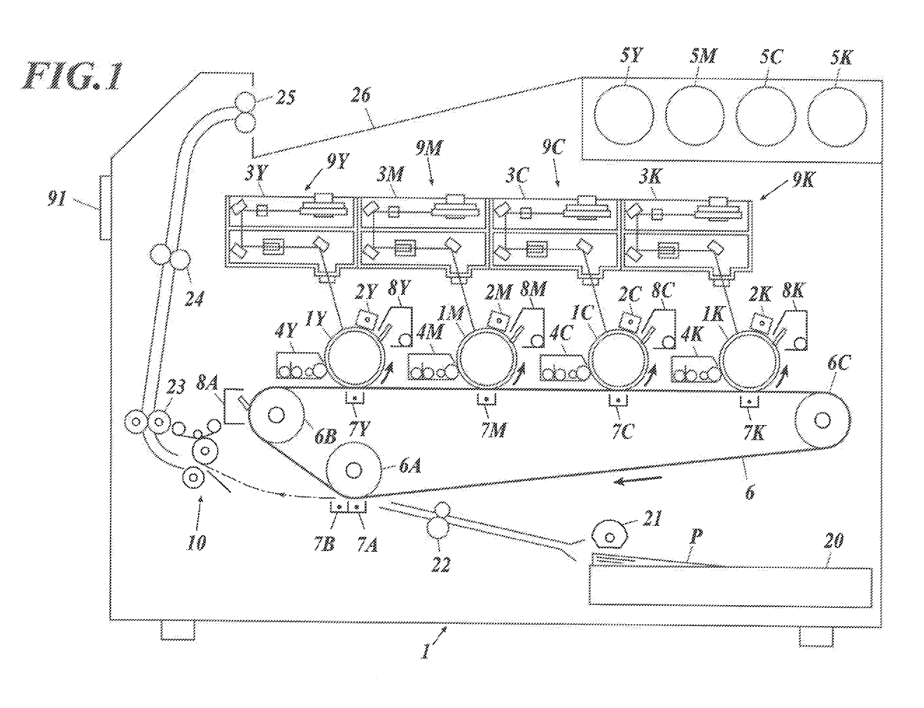

FIG. 1 is a schematic diagram illustrating an example of an image forming apparatus. As illustrated in FIG. 1, this image forming apparatus 1 is a so-called tandem type color image forming apparatus. It is composed of a plurality of sets of image forming units 9Y, 9M, 9C, and 9K, a belt-shaped intermediate transfer member 6, toner cartridges 5Y, 5M, 5C, and 5K, a fixing device 10, and an operation unit 91.

The image forming unit 9Y which forms a yellow color image has a charging device 2Y, an exposing device 3Y, a developing device 4Y, a transfer device 7Y, and a cleaning device 8Y disposed around an image carrier 1Y (hereafter, it is referred to as a photoreceptor).

The image forming unit 9M which forms a magenta color image has a photoreceptor 1M, a charging device 2M, an exposing device 3M, a developing device 4M, a transfer device 7M, and a cleaning device 8M.

The image forming unit 9C which forms a cyan color image has a photoreceptor 1C, a charging device 2C, an exposing device 3C, a developing device 4C, a transfer device 7C, and a cleaning device 8C.

The image forming unit 9K which forms a black color image has a photoreceptor 1K, a charging device 2K, an exposing device 3K, a developing device 4K, a transfer device 7K, and a cleaning device 8K.

The intermediate transfer member 6 is wound around a plurality of rollers 6A, 6B, and 6C, and is rotatably supported.

Images of respective colors formed by the image forming units 9Y, 9M, 9C, and 9K are sequentially primarily transferred by the transfer devices 7Y, 7M, 7C, and 7K onto the rotating intermediate transfer member 6, and the synthesized color images is formed.

Papers P accommodated in a paper feed cassette 20 serving as a paper feed device are fed one by one by a paper feed roller 21 and conveyed to a transfer device 7 A via a registration roller 22 so that the color image is secondarily transferred.

The paper P to which the color image has been transferred is subjected to a fixing process by the fixing device 10 and is conveyed through conveyance rollers 23 and 24 which are conveyance devices and is nipped by a discharge roller 25 and placed on a discharge tray 26 outside the machine.

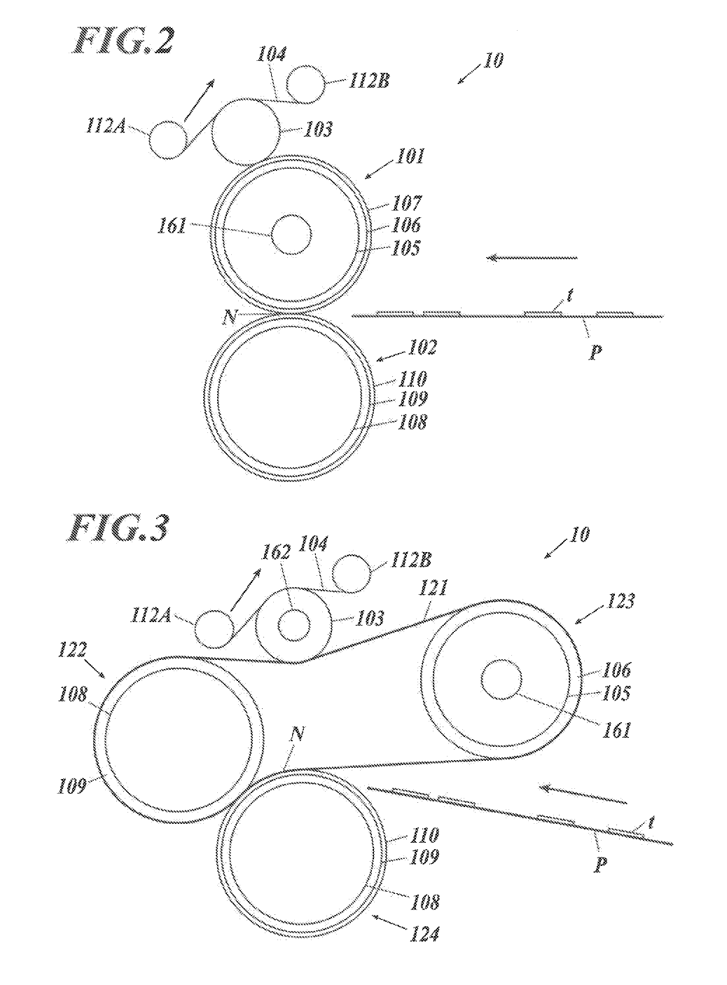

FIG. 2 is a schematic cross-sectional view of the fixing device 10. As illustrated in FIG. 2, the fixing device 10 has a heat fixing rotating roller (also referred to as “heat fixing roller” or “fixing rotating roller”) 101 as a fixing rotating body. Further, the fixing device 10 has a cleaning rotating roller (also referred to as “cleaning roller”) 103 which is a cleaning rotating body according to the present invention and a cleaning web 104 which is a cleaning member according to the present invention. Thereby the residual toner component adhering to the heat fixing roller 101 is homogenized or removed.

The heat fixing roller 101 is, for example, a pressure rotating body, and it forms a fixing nip portion N with a pressure roller 102 pressed against the heat fixing roller 101. The transfer material P having the toner t is passed through the fixing nip portion N and heat fixing is performed. By the heat fixing at the nip portion N, the toner t is melted and fixed on the transfer material P. At this time, the components (resin, releasing agent) contained and dispersed in the toner t are dissolved and become present at a predetermined amount or more at the interface between the heat fixing roller 101 and the melted toner resin. Therefore, the adhesive force between the toner resin and the heat fixing roller 101 decreases, offset and wrapping of the transfer material are suppressed, and a part of toner components such as releasing agent adheres to the heat fixing roller 101.

The heat fixing roller 101 is, for example, a device formed by a resistant elastic layer 106 of silicone rubber having a thickness of 1.5 mm formed on an aluminum cylindrical core metal 105 containing a halogen heater 161 as a heating source, and further, a toner releasing layer 107 of PFA resin having a thickness of 30 μm formed by coating and baking a dispersion state PFA resin on the uppermost surface of the resistant elastic layer 106 through 1 to 3 adhesive layers interposed. The heat fixing roller 101 is driven to rotate by a motor (not shown). Further, as a toner releasing layer 107 of the PFA resin, a PFA tube molded as a tube may be coated on the heat resistant elastic layer 106 via an adhesive layer for the heat fixing roller 101.

A pressure roller 102 is formed as follows. A heat resistant elastic layer 109 of silicone rubber having a thickness of 1.0 mm was formed on an aluminum cylinder metal core 108, and a toner separation later 110 made of PFA resin having a thickness of 30 μm was formed on the outermost surface of the heat resistant elastic layer 109 via one to three adhesive layers. The pressure roller 102 presses the transfer paper P having the toner image t with the heat fixing roller 101, and it is driven to rotate while applying pressure. The toner releasing layer 110 is formed in the same manner as the above-described toner releasing layer 107.

For the toner releasing layer 107, it is preferable to use a material containing a fluororesin. A more preferable fluororesin is a material containing any of PFA resin (perfluoroalkoxy fluorine resin), PTFE resin (polytetrafluoroethylene resin), FEP (tetrafluoroethylene/hexafluoropropylene copolymer). This improves the releasability of the surface of the heat fixing roller 101 with respect to the releasing agent contained in the toner resin and the toner particles, and makes it difficult for the toner to stick to the surface of the heat fixing roller 101 at the time of fixing. Moreover, the residual toner component hardly adheres to the surface of the heat fixing roller 101, and even if the residual toner component adheres to the surface of the heat fixing roller 101, it is possible to further improve the effect of removing the residual toner component by the cleaning roller 103, and it is possible to further suppress the gloss memory.

The thickness of the toner releasing layer 107 of the heat fixing roller 101 is preferably 20 to 50 μm. By setting the thickness to 20 μm or more, it is easy to form a uniform fluororesin layer. Further, by setting the thickness to be 50 μm or less, the surface of the heat fixing roller 101 can be made to easily follow the surface unevenness of the transfer paper P carrying the toner image t, and image deterioration can be suppressed. In addition, in the region of 50 μm or less, since the surface of the heat fixing roller 101 easily fits the surface of the cleaning roller 103, the effect of removing the releasing agent by the cleaning roller 103 can be further improved.

The cleaning roller 103 is, for example, a device formed by subjecting an aluminum cylindrical core metal to a hard anodizing treatment to form an alumina film, and further performing secondary electrolysis in an ammonium tetrathiomolybdate solution to form molybdenum disulfide, and then the surface is polished. It is preferable that the surface roughness Rz of the portion in contact with the heat fixing roller 101 is 1.6 μm or less and the Vickers hardness is 350 kg/mm² or more. In addition, a halogen heater can be installed inside the aluminum cylinder of the cleaning roller 103 to serve also as an external heating roller.

It is preferable to use a material having a surface roughness Rz of 1.6 μm or less and having heat resistance to the surface temperature of the heat fixing roller 101 as the material of the cleaning roller 103 in contact with the heat fixing roller 101. In addition to the above-mentioned ones, it is also possible to form a foamed silicone rubber with a thickness of about 3 to 8 mm so as to have an Asker-C (500 gf load) hardness (hardness) of 15 to 50° on an aluminum cylinder metal core. And further it is preferably used a device coated with a polyimide seamless tube molded to have a thickness of about 50 to 80 μm and an surface roughness Rz of 1.6 μm or less via an adhesive layer. In the present specification, “surface roughness Rz” means a value of reference length of 0.8 mm described in JIS B 0601-1982. That is, it is the difference between the average height of the top five peaks and the average depth of the bottom five valleys between distances of the reference length of 0.8 mm.

It is particularly preferable that the surface roughness Rz of the portion of the cleaning roller 103 in contact with the heat fixing roller 101 is 1.0 μm or less. When the temperature on the heat fixing roller 101 is kept equal to or higher than the melting point of the releasing agent, the releasing agent is in a liquid state, and its height is usually about 1 μm or less. Consequently, by setting the surface roughness Rz to a small value as described above, contact between the release agent and the cleaning roller 103 is more reliable. Thereby it is possible to more efficiently wipe off the releasing agent adhering to the heat fixing roller 101.

The cleaning roller 103 is in contact with the heat fixing roller 101 with a load of 2 to 10 kgf (19.6 to 98.1 N), and the halogen heater 161 is adjusted so that the temperature at the contact portion is higher than the melting point of the releasing agent contained in the toner. This makes it possible to wipe off the releasing agent adhering to the heat fixing roller 101 by the cleaning roller 103 in a state of being dissolved and it is possible to suppress the gloss memory by improving the releasing agent removal efficiency from the heat fixing roller 101.

The contact portion between the cleaning roller 103 and the heat fixing roller 101 is preferably equal to or larger than the maximum sheet width of the transfer material P used for image formation. It is also preferable that the contact portion between the cleaning web 104 and the cleaning roller 103 be equal to or larger than the maximum sheet width of the transfer material P used for image formation. This makes it possible to eliminate gloss memory for any type of paper.

Further, the cleaning roller 103 is also in contact with the cleaning web 104, and due to the heat from the heat fixing roller 101 heated by the halogen heater 161, the temperature at the contact portion between the cleaning roller 103 and the cleaning web 104 is higher than the melting point of the releasing agent contained in the toner. In this way, when the releasing agent attached to the heat fixing roller 101 is wiped away, the releasing agent attached to the cleaning roller 103 is wiped off by the cleaning web 104 in a dissolved state. It is possible to improve the releasing agent removing efficiency from the cleaning roller 103. The melting point of the releasing agent contained in the toner is usually as low as about 110° C. or less. Further, the heat fixing roller 101 is always supplied with heat from the halogen heater 161, the surface temperature is usually maintained at about 160° C. or higher. Since the heat fixing roller 101 and the cleaning roller 103 rotate in contact with each other, the temperature at the contact portion between the cleaning roller 103 and the cleaning web 104 is also higher than the melting point of the releasing agent.

For example, in the cleaning roller 103 in which an alumina coating film is formed on an aluminum cylinder metal core and polished, since the thermal conductivity of the core metal is good, the surface temperature immediately increases due to contact with the heat fixing roller 101. The wall thickness of the aluminum cylindrical core metal is preferably as thin as possible in the range where no bending occurs and so the surface temperature can be immediately increased, and it is preferably about 0.8 to 2 mm. Also in the case of the cleaning roller 103 in which the surface of the foamed silicone rubber is covered with a polyimide tube, the surface temperature immediately rises due to the contact rotation with the heat fixing roller 101 due to poor thermal conductivity of the foamed silicone rubber.

It is preferable that the heat fixing roller 101 and the cleaning roller 103 are provided with a rotating period during warm-up term. By this, it is possible to make it to a sufficiently high temperature just after the start of the image forming apparatus.

When the contact angle at a predetermined temperature T (° C.) in the range of the melting point of the releasing agent to 230° C. or lower with respect to the releasing agent contained in the toner on the surface portion of the cleaning roller 103 in contact with the heat fixing roller 101 is defined as “A”, and the contact angle at the predetermined temperature T (° C.) with respect to the releasing agent contained in the toner on the surface portion of the heat fixing roller 101 in contact with the cleaning roller 103 is defined as “B”, it is preferable that A<B. By doing in this way, at the contact portion between the heat fixing roller 101 and the cleaning roller 103, the releasing agent having a temperature higher than the melting point and attached to the heat fixing roller 101 is easily moved from the heat fixing roller 101 to the cleaning roller 103. As a result, the releasing agent removal efficiency from the heat fixing roller 101 is further improved, and the gloss memory can be further suppressed. The temperature range in which the magnitude relation of the contact angle needs to be maintained is preferably not less than the melting point of the releasing agent and the maximum temperature in the normal use state of the surface of the fixing rotating body (the temperature at which the fluororesin on the surface of the fixing rotating body keeps sufficiently endurance).

In the present invention, it is preferable that the thickness of the heat resistant elastic layer 106 of the heat fixing roller 101 is 0.2 mm or more, and the cleaning roller 103 has a Vickers hardness of 350 kg/mm2 or more at a portion in contact with the heat fixing roller 101, and the cleaning roller 103 is pressed against the heat fixing roller 101 with a load of 2 to 10 kgf (19.6 to 98.1 N). By setting the thickness of the heat resistant elastic layer 106 of the heat fixing roller 101 to 0.2 mm or more, the surface of the heating roller easily follows the surface unevenness of the transfer paper P carrying the toner image t, and the image quality is improved. In addition, even if the cleaning roller 103 is hard, the contact between the cleaning roller 103 and the heat fixing roller 101 is stabilized, and the releasing agent attached to the heat fixing roller 101 at the contact portion between the heat fixing roller 101 and the cleaning roller 103 is easily move to the cleaning roller 103 from the heat fixing roller 101. Thereby the releasing agent removal efficiency from the heat fixing roller 101 is further improved, and the gloss memory can be further suppressed.

In addition, by setting the Vickers hardness to 350 kg/mm² or more, it is possible to suppress generation of abrasion powder due to abrasion by the cleaning web 104 with which the cleaning roller 103 abuts or adhering paper powder, or it is possible to suppress increase of the surface roughness Rz of the cleaning roller. As a result, the cleaning effect of the cleaning roller 103 can be maintained.

The cleaning roller 103 is in pressure contact with the heat fixing roller 101 with a load of 2 to 10 kgf. By this the pressure contact between the cleaning roller 103 and the heat fixing roller 101 is stabilized, and even if the cleaning web 104 is in a contact state, the cleaning roller 103 can stably follow the heat fixing roller 101 and does not damage the heat resistant elastic layer of the heat fixing roller 101.

The Vickers hardness is defined as the hardness that is measured according to the microhardness test method of JIS Z 2251. Specifically, using a diamond regular square pyramidal indenter with a face-to-face angle of 136 degrees, the load F (kgf) when an indentation is formed on the test surface is divided by the surface area determined from the diagonal length d (mm) of the indentation. The obtained quotient is defined as the Vickers hardness. It is obtained by the following expression.

Surface hardness (Hv)=1.8544 F/d²

(d is an average (mm) of the diagonal length of the indentation)

In the present invention, it is a value measured with MVK-H 100 (manufactured by Akashi Co., Ltd.) in an environment of 23° C. and 50% RH.

The cleaning web 104 serving as a cleaning member is, for example, in the form of a sheet, and a nonwoven fabric in which an aromatic polyamide fiber and a polyester fiber are combined at a mass ratio of 6:4 with a thickness of 70 μm and a basis weight of 27 g/m² may be used. Further, for the cleaning web 104, it is possible to use a nonwoven fabric made by combining aromatic polyamide fibers and polyester fibers at a mass ratio of 4:6 with a thickness of 46 μm and a basis weight of 27 g/m².

Further, for example, in the case where the cleaning web 104 is not used, the releasing agent accumulates on the cleaning roller 103, or toner and paper dust slightly offset accumulate on the heat fixing roller 101. As a result, the cleaning ability of the release agent of the cleaning roller 103 gradually deteriorates. By providing the cleaning web 104, the toner adhering to the cleaning roller 103, the paper dust, and the releasing agent may be more efficiently wiped off, so that the cleaning effect may be maintained and improved.

Any material may be used for the cleaning web 104 as long as it can wipe off the releasing agent above the melting point from the cleaning roller 103. It is preferably a nonwoven fabric containing at least one of an aromatic polyamide fiber and a polyester fiber. Since these nonwoven fabrics are close to the structure of the resin constituting the toner particles and the releasing agent, it is possible to more surely collect dirt attributable to these constituent components attached to the rotating member.

The cleaning web 104 is placed so that it is stretched with a tension between the original winding side 112 A and the winding side 112 B which are the cleaning member moving means according to the present invention and the cleaning roller 103 is in contact with the cleaning web 104. By using a drive motor (not illustrated), the axis of the take-up side 112B of the sheet-like cleaning web is rotated by a predetermined angle to move the cleaning web 104. By this, the cleaning roller 103 is cleaned with the cleaning web 104, and the dirty portion thereof is moved. It is possible to clean the cleaning roller 103 so that a large amount of toner, paper dust, and releasing agent do not accumulate at the contact portion between the cleaning web 104 and the cleaning roller 103, and generation of the glossy memory can be further suppressed. It is preferable that the amount of movement of the cleaning web 104 as the cleaning member is wound up within the range of 0.1 μm to 1 mm per A4 size paper because it makes cleaning more efficiently. It is preferable to keep the cleaning roller 103 at a constant moving value within the range of 0.02 to 0.05 mm per A4 size paper since cleaning of the cleaning roller 103 is sufficiently performed, and it is not necessary to make the length of the cleaning web 104 longer than necessary from the viewpoint of space and cost.

It is possible to control the moving amount of the cleaning web 104 to a predetermined value by setting the driving time of the cleaning web driving motor to be a value calculated by an expression using the cumulative driving time of the cleaning web driving motor from the state where the new cleaning web 104 is attached as a function.

The heat fixing roller 101 is not applied with a silicone oil. By doing this, the image quality can be further improved and the cost can be reduced.

Also, the cleaning web 104 is not impregnated with a silicone oil. As a result, image quality can be further improved and costs can be reduced.

As an example of a device for removing the releasing agent on the surface of the uniformizing member (cleaning roller 103) for equalizing the releasing agent amount on the surface of the fixing rotating body (heat fixing roller 101), use of the cleaning web 104 was explained. However, other device may be used as long as the releasing agent can be removed.

With respect to the above-described fixing device 10, a device of a roller fixing method was described. This device is composed of a fixing roller as a fixing rotating body and a pressure roller as a pressure member that is provided in a state of being pressed to the fixing roller so as to form a fixing nip portion on the fixing roller. The fixing device 10 of the present invention is not limited to this. Further, a belt fixing method in which the fixing rotating body is constituted by a fixing belt may also be adopted. This will be described later.

FIG. 3 illustrates a schematic diagram of a fixing device 10 adopting the belt fixing method. In the fixing device 10 illustrated in FIG. 3, a fixing belt 121 as a fixing rotating body is supported by an upper pressure roller 122 and a support heating roller 123. The support heating roller 123 is rotationally driven by a motor (not shown) to rotate the fixing belt 121. The fixing belt 121 is heated by the support heating roller 123.

In the fixing device 10 illustrated in FIG. 3, a nip portion N is formed by the fixing belt 121 supported by the upper pressure roller 122 and the support heating roller 123 and a lower pressure roller 124. The transfer material P having the toner t is passed through the fixing nip portion N to conduct thermal fixing.

Further, the fixing device 10 is provided with a cleaning roller 103, which is provided so as to be in contact with the fixing belt 121 and serves as a uniformizing member for equalizing the amount of releasing agent on the surface of the fixing belt 121. The fixing device 10 is provided with a cleaning web 104 which is provided so as to come into contact with the cleaning roller 103 as a uniformizing member and is a means for removing the releasing agent on the surface of the cleaning roller 103. With these configurations, it is possible to uniformize the releasing agent adhered to the heat fixing roller 101 by the cleaning roller 103 while removing the releasing agent attached to the cleaning roller 103.

Further, as illustrated in FIG. 3, even when the fixing rotating body is the fixing belt 121, it is preferable that the temperature of the contact portion between the fixing belt 121 and the cleaning roller 103, and the temperature of the contacting portion between the cleaning roller 103 and the cleaning web 104 are made higher than the melting point of the releasing agent contained in the used toner, so as to wipe off the releasing agent on the fixing belt 121 in a dissolved state by the cleaning roller 103 having a surface roughness Rz of 1.6 μm or less. Furthermore, by wiping the releasing agent adhering to the cleaning roller 103 in a dissolved state using the cleaning web 104, generation of gloss memory can be suppressed.

Inside the supporting heating roller 123 and the cleaning roller 103 illustrated in FIG. 3, halogen heaters 161 and 162 are provided. Further, the fixing device 10 uses the halogen heater 161 of the support heating roller 123 and the halogen heater 162 of the cleaning roller 103 to adjust the temperature at the contact portion between the fixing belt 121 and the cleaning roller 103 and the temperature at the contact portion between the cleaning roller 103 and the cleaning web 104 to be higher than the melting point of the releasing agent. In such a case where the cleaning roller 103 and the support heating roller 123 are separated from each other, the cleaning roller 103 may be further provided with a halogen heater 162 as a heat source to heat the cleaning roller 103. As a result, it is possible to easily control the temperature of the contact portion.

### [Electrostatic Image Developing Toner]

An “electrostatic image developing toner (Toner)” according to the present invention designates an aggregate of “toner particles”. Further, the “toner particles” according to the present invention contain at least a crystalline resin and a releasing agent. Further, it is preferable that the toner particles contain, for example, an internal additive such as a releasing agent and a colorant in the binder resin. In general, toner particles to which external additives are added are preferably used as toner particles, but the external additives may not be added. It is also preferable that the toner particles contain an internal additive such as a charge controlling agent and a surfactant, if necessary.

### <Binder Resin>

The toner particle binder resin of the present invention preferably contains an amorphous resin and a crystalline resin.

### (Amorphous Resin)

As the amorphous resin, it is preferable to use an amorphous vinyl polymer (also referred to simply as a vinyl resin in this specification) formed using a vinyl-based monomer.

### (Amorphous Vinyl Polymer)

As an amorphous vinyl polymer, it can be specifically cited an acrylic resin, and a styrene-acrylic co-polymer resin.

As vinyl monomers to form an amorphous vinyl polymer, the following may be used. The vinyl monomers may be used alone, or may be used in combination of two or more kinds.

(1) Styrene monomers: styrene, o-methylstyrene, m-methylstyrene, p-methylstyrene, α-methylstyrene, p-chlorostyrene, 3,4-dichlorostyrene, p-phenylstyrene, p-ethylstyrene, 2,4-dimethylstyrene, p-t-butylstyrene, p-n-hexylstyrene, p-n-octylstyrene, p-n-nonylstyrene, p-n-decylstyrene, p-n-dodecylstyrene, and derivatives of these monomers.
(2) (Meth)acrylic acid ester monomers: methyl (meth)acrylate, ethyl (meth)acrylate, n-butyl (meth)acrylate, iso-propyl (meth)acrylate, iso-butyl (meth)acrylate, t-butyl (meth)acrylate, n-octyl (meth)acrylate, 2-ethylhexyl (meth)acrylate, stearyl (meth)acrylate, lauryl(meth)acrylate, phenyl (meth)acrylate, diethylaminoethyl (meth)acrylate and dimethylaminoethyl (meth)acrylate, and derivatives of these monomers.
(3) Vinyl esters: vinyl propionate, vinyl acetate, and vinyl benzoate.
(4) Vinyl ethers: vinyl methyl ether and vinyl ethyl ether.
(5) Vinyl ketones: vinyl methyl ketone, vinyl ethyl ketone and vinyl hexyl ketone.
(6) N-vinyl compounds: N-vinyl carbazole, N-vinyl indole, and N-vinyl pyrrolidone.
(7) Others: vinyl compounds such as vinylnaphthalene and vinylpyridine; acrylic acid or methacrylic acid derivatives such as acrylonitrile, methacrylonitrile, and acrylamide.

It is preferable to use vinyl monomers containing ionic-dissociative group such as a carboxy group, a sulfonic acid group or a phosphoric acid group. Specific examples are as follows.

Examples of a monomer containing a carboxy group are: acrylic acid, methacrylic acid, maleic acid, itaconic acid, cinnamic acid, fumaric acid, monoalkyl maleate, and monoalkyl itaconate. Examples of a monomer containing a sulfonic acid group are: styrenesulfonic acid, allylsulfosuccinic acid, and 2-acrylamido-2-methylpropanesulfonic acid. An example of a monomer containing a phosphoric acid group is acid phosphooxyethyl methacrylate.

In the present invention, it is preferable to use a monomer containing a carboxy group as a vinyl monomer. A content of a monomer containing a carboxy group in the total vinyl monomers is preferably in the range of 2 to 7 mass %. When the content of a monomer containing a carboxy group is within this range, an amount of water adsorbed to the surface of toner particles will not be increased, and it can control generation of toner blister or increase of environmental difference of charge amount.

Further, the amorphous vinyl polymer may be changed into a cross-linked resin by using poly-functional vinyl compounds as vinyl monomers. Examples of a poly-functional vinyl compound include: divinylbenzene, ethylene glycol dimethacrylate, ethylene glycol diacrylate, diethylene glycol dimethacrylate, diethylene glycol diacrylate, triethylene glycol dimethacrylate, triethylene glycol diacrylate, neopentylglycol dimethacrylate, and neopentylglycol diacrylate.

A preferable amorphous vinyl polymer is a styrene-acrylic resin formed with a styrene monomer and an alkyl (meth)acrylate monomer. Examples of an alkyl (meth)acrylate monomer are as follows. As a monomer having a straight-chain alkyl group, it can be cited: n-butyl acrylate (having a straight-chain alkyl group of 4 carbon atoms) and n-octyl acrylate (having a straight-chain alkyl group of 8 carbon atoms). As a monomer having a branched alkyl group, it can be cited: 2-ethylhaxyl acrylate (having a branched-chain alkyl group of 8 carbon atoms), isostearyl acrylate (having a branched alkyl group of 18 carbon atoms), behenyl acrylate (having a branched alkyl group of 22 carbon atoms), cellothyl acrylate (having a branched alkyl group of 26 carbon atoms), 2-ethylhexyl methacrylate, 1-methylheptyl acrylate, 2-propylheptyl acrylate, 6-methylheptyl acrylate, isooctyl acrylate, isononyl acrylate, isodecyl acrylate, tridecyl acrylate, and tridecyl methacrylate.

A preferable alkyl (meth)acrylate monomer contains a structure unit represented by Formula (1) from the viewpoint of obtaining excellent low-temperature fixability and thermal resistivity. When an alkyl (meth)acrylate monomer having a long chain alkyl group (in the range of 6 to 22 carbon atoms) is incorporated in the amorphous vinyl polymer, it becomes possible to encapsulate or to control the dispersion of the crystalline polyester in the toner. Thus, it is supposed that it can obtain further excellent low-temperature fixability and thermal resistivity.

H₂C═CR¹—COOR² Formula (1)

In Formula (1), R¹ represents a hydrogen atom or a methyl group; and R² represents an alkyl group of 6 to 22 carbon atoms.

When R² in Formula (1) represents an alkyl group in the range of 6 to 22 carbon atoms, an excellent low-temperature fixability and thermal resistivity can be achieved. This is a preferable embodiment.

From the viewpoint of further improving the document offset property, it is preferable that the above-described amorphous vinyl polymer is contained in the toner particles in the range of 10 to 90 mass %, more preferably in the range of 50 to 80 mass %.

### <Crystalline Resin>

In the present invention, a crystalline resin is a resin exhibiting a clear endothermic peak measured with differential scanning calorimetry (DSC), instead of a stepwise change of heat absorption. Here, “a clear endothermic peak” designates a peak having a half bandwidth within 15° C. in an endothermic curve obtained by measurement with differential scanning calorimetry (DSC) under the condition of a temperature raising rate of 10° C./min.

It is preferable that the crystalline resin is contained in the toner particles within the range of 3 to 25 mass % from the viewpoints of color contamination prevention property, low-temperature fixability. By setting the content of the crystalline resin to 3 mass % or more, it is possible to sufficiently obtain the effect of suppressing electrostatic offset by the crystalline resin and to effectively obtain the effect of the present invention. By setting the content of the crystalline resin to 25 mass % or less, it is possible to suppress the decrease in the toner resistance and to suppress occurrence of transfer failure due to the reduction in toner resistance. As a result, it is possible to suppress occurrence of mixed color contamination and image density unevenness.

From the viewpoint of suppression of image density unevenness and white background toner stain, it is preferable that the average number of dispersed particle diameter of the particles of the crystalline resin is 1.0 μm or less. This is also preferable from the viewpoints of preventing color contamination and low-temperature fixability. By setting the average number of dispersed particles of the crystalline resin particles to a small particle size of 1.0 μm or less, the dispersibility of the crystalline resin in the toner particles becomes high. It is possible to suppress the decrease in the toner resistance and to suppress occurrence of transfer failure due to the reduction in toner resistance. As a result, it is possible to suppress occurrence of mixed color contamination and image density unevenness.

A method of measuring the average number of dispersed particle diameter of the particles (domains) of the crystalline resin contained in the toner particles will be described below.

### (1. Method of Preparing Section of Toner Particles)

Toner particles are dyed with ruthenium tetroxide (RuO₄) vapor by using a vacuum electron dyeing apparatus VSC1R1 (manufactured by Filgen Co. Ltd.) under the conditions of room temperature (24 to 25° C.), concentration 3 (300 Pa), for 10 minutes. The dyed sample is dispersed in a photocurable resin “D-800” (manufactured by JEOL Ltd.) and hardened by UV light to form a block. Then, using a microtome equipped with diamond blade, ultrathin plate samples in the range of 60 to 100 nm in thickness are cut out from the above block.

### (2. Observation of Cross Section of Toner Particles)

An ultrathin sample dyed with ruthenium tetroxide (RuO₄) is observed under conditions of an acceleration voltage of 80 kV and a magnification of 50,000 (bright field image) using a transmission electron microscope “JEM-2000FX” (manufactured by JEOL Ltd.).

### (3. Measuring Method of Average Dispersed Particle Diameter and Average Dispersion Number)

A section of the toner particle is photographed, and a photographic image is captured by a scanner. The photographic image is analyzed by the image processing analyzing apparatus “LUZEX AP” (manufactured by Nireco Corporation). With respect to the particles (domain) of the crystalline resin in the cross section of the toner particle, the horizontal rear maximum chord length is measured as the dispersed particle diameter, and the number of each particle is measured as the dispersed number. In the present invention, a cross section of toner particles having a long axis diameter of 3 μm or more in the cross section of the toner particles is measured. Here, the average number dispersed particle diameter is calculated from the average dispersed particle size based on the number of domains, using, for example, 100 arbitrarily selected cross-sections for 100 toner particles with arbitrarily selected operations described above.

### (Crystalline Polyester Resin)

Although the kind of the crystalline resin is not limited in particular, it is preferable to be a crystalline polyester resin in order to achieve low-temperature fixability. A crystalline polyester resin will easily adsorb water due to the presence of an ester bond in the resin. By this, release of charge will be promoted and it can control the sticking of sheets of paper having a thermally fixed image thereon. This is a preferable embodiment.

The crystalline polyester resin according to the present invention can be obtained by a polycondensation reaction between a two or more valent alcohol (a polyhydric alcohol component) and a two or more valent carboxylic acid (a polycarboxylic acid component). In the present invention, “a crystalline polyester resin” indicates a resin which exhibits a clear endothermic peak among the above-described crystalline polyester resin.

The content of the crystalline polyester resin contained in the toner of the present invention is preferably 2 to 20 mass %, and more preferably 5 to 15 mass % of the binder resin.

A polycarboxylic acid is a compound containing two or more carboxy group in one molecule. Specific examples of thereof are: saturated aliphatic dicarboxylic acids such as oxalic acid, succinic acid, adipic acid, sebacic acid, azelaic acid, and n-dodecyl succinic acid; an alicyclic dicarboxylic acid such as cyclohexane dicarboxylic acid; an aromatic dicarboxylic acid such as terephthalic acid; polycarboxylic acids of 3 valent or more such as trimellitic acid, and pyromellitic acid; and acid anhydrides and alkyl esters of 1 to 3 carbon atoms of these compounds. These compounds may be used alone, or may be used in combination of two or more kinds.

The polyhydric alcohol is a compound having two or more hydroxyl groups in the molecule. Specific examples thereof include: aliphatic diols such as 1,2-propanediol, 1,3-propanediol, 1,4-butanediol, 1,5-pentanediol, 1,6-hexanediol, 1,7-heptanediol, 1,8-octanediol, neopentyl glycol and 1,4-butenediol; tri- or more hydric alcohols such as glycerin, pentaerythritol, trimethylol propane and sorbitol. These compounds may be used alone, or may be used in combination of two or more kinds.

From the viewpoint of obtaining sufficient low-temperature fixability, the melting point of the crystalline polyester resin is preferably from 60 to 90° C., more preferably from 70 to 85° C. The melting point of the crystalline polyester resin can be adjusted by changing the resin composition.

The melting point of the crystalline polyester resin indicates the peak top temperature in the endothermic peaks, and it is a value measured with a differential scanning calorimeter “Diamond DSC” (PerkinElmer Inc.), for example.

Specifically, 1.0 mg of measuring sample (crystalline polyester resin) is enclosed in an aluminum pan (KIT NO. B0143013), and it is set to a sample holder of Diamond DSC. The measuring is done in the temperature range of 0 to 200° C., with temperature increasing rate of 10° C./min, and temperature decreasing rate of 10° C./min. The temperature control of heating-cooling-heating are conducted. And the data obtained in the second heating is analyzed.

The number average molecular weight (Mn) of the crystalline polyester resin is preferably from 1,000 to 15,000 from the viewpoint of low-temperature fixability and glossiness stability. The number average molecular weight (Mn) is a value measured with gel permeation chromatography (GPC) as follows.

Specifically, a device “HLC-8120GPC” (TOSOH Corp.) and a column set “TSK guard column+3×TSK gel Super HZM-M” (TOSOH Corp.) are used. The column temperature is held at 40° C., and tetrahydrofuran (THF) is supplied at a flow rate of 0.2 ml/min as a carrier solvent. The measuring sample (resin) is dissolved in tetrahydrofuran to a concentration of 1 mg/mL by a treatment with an ultrasonic disperser at room temperature for 5 minutes. The solution is then treated with a membrane filter having a pore size of 0.2 μm to obtain a sample solution. An aliquot (10 μl) of the sample solution is injected into the device along with the carrier solvent and is detected by means of a refractive index (RI) detector. The molecular weight distribution of the sample is calculated by using a calibration curve, which is determined by using standard monodisperse polystyrene particles. 10 kinds of polystyrene particles were used for making a calibration curve.

### (Hybrid Resin)

Although the crystalline polyester resin may be composed of 100 mass % of the crystalline polyester resin segment, the crystalline polyester resin may be preferably a hybrid crystalline polyester resin in which a crystalline polyester polymerization segment and an amorphous polymerization segment are bonded with a chemical bond (hereafter, it may be simply called as a hybrid resin). Namely, the crystalline polyester resin may be a vinyl modified crystalline polyester resin (a hybrid resin) in which a vinyl resin segment and a crystalline polyester resin segment are bonded. Preferably, the vinyl resin segment is a styrene-acrylic resin segment, and the content thereof is 5 to 30 mass % in the hybrid resin. A particularly preferable content thereof is 5 to 20 mass %. As a result, the dispersed particle diameter of the crystalline resin in the toner can be controlled to a desired value as described above.

The crystalline polyester resin segment indicates a molecular chain that constitutes the crystalline polyester resin. The amorphous resin segment indicates a molecular chain that constitutes the amorphous resin which does not form a crystalline structure.

A weight average molecular weight (Mw) of the hybrid resin of the present invention is preferably in the range of 5,000 to 100,000, more preferably in the range of 7,000 to 50,000, and still more preferably in the range of 8,000 to 40,000 from the viewpoint of securely obtaining a good balance of sufficient low-temperature fixability and highly prolonged storage stability.

By making the weight average molecular weight (Mw) of the hybrid resin to be 100,000 or less, sufficient low-temperature fixability may be obtained. On the other hand, by making the weight average molecular weight (Mw) of the hybrid resin to be 5,000 or more, exceeded mutual dissolving of the hybrid resin and the amorphous resin can be controlled, and an image failure caused by coalition of toners may be effectively prevented.

### (Crystalline Polyester Resin Segment in Hybrid Resin)

The crystalline polyester resin segment of the present invention indicates a portion derived from a known polyester resin formed by a polycondensation reaction of a carboxylic acid of a divalent or more (polycarboxylic acid) with an alcohol of a divalent or more (polyhydric alcohol). It is a resin segment having a clear endothermic peak as described above instead of stepwise change of heat absorption in the measurement of differential scanning calorimetry of toner.

The crystalline polyester resin segment according to the present invention is not limited in particular as long as it has a structural feature as described above.

For example, the following correspond to a hybrid resin having a crystalline polyester resin segment as long as a toner containing the following resin has a clear endothermic peak as described above. They are: a resin having a main chain of a crystalline polyester resin segment copolymerized with other component; and a resin having a main chain of other component copolymerized with a crystalline polyester resin segment.

As a valence number of polycarboxylic acid and polyhydric acid, preferably it is 2 or 3 respectively. A particularly preferable valence number is 2. Therefore, it will be described the most preferable embodiment having a valence number 2 (namely, about a dicarboxylic acid component and a diol component).

A preferable dicarboxylic acid component is an aliphatic dicarboxylic acid. It may be jointly used an aromatic dicarboxylic acid. A preferable aliphatic dicarboxylic acid is a straight alkyl type. By using the straight alkyl type, it will be produced an advantage of improving a crystalline property. The dicarboxylic acid component is not limited to use one kind, it may be used two or more kinds.

Examples of an aliphatic dicarboxylic acid include: oxalic acid, malonic acid, succinic acid, glutaric acid, adipic acid, pimelic acid, suberic acid, azelaic acid, sebacic acid, 1,9-nonane dicarboxylic acid, 1,10-decane dicaroxylic acid, 1,11-undecane dicarboxylic acid, 1,12-dodecane dicarboxylic acid (dodecanedioic dicarboxylic acid), 1,13-tridecane dicarboxylic acid, 1,14-tetradecane dicarboxylic acid, 1,16-hexadecane dicarboxylic acid, and 1,18-octadecane dicarboxylic carboxylic acid. It can be used a low alkyl ester or an acid anhydride of these compounds.

Among the above-described aliphatic dicarboxylic acids, preferable are aliphatic dicarboxylic acids having 6 to 12 carbon atoms. Examples of an aromatic dicarboxylic acid which may be used with the aliphatic dicarboxylic acid are: terephthalic acid, isophthalic acid, orthophthalic acid, t-butyl isophthalic acid, 2,6-naphthalene dicaroxylic acid, and 4,4′-biphenyl dicarboxylic acid. Among these, from the viewpoint of easy availability and easy emulsification, it is preferable to use: terephthalic acid, isophthalic acid and t-butyl isophthalic acid.

As a dicarboxylic acid component for forming a crystalline polyester resin segment, it is preferable that the content of the aliphatic dicarboxylic acid is 50 mole % or more, more preferably 70 mole % or more, still more preferably 80 mole % or more, and most preferably 100 mole %. By making the content of the aliphatic dicarboxylic acid in the dicarboxylic acid component to be 50 mole % or more, it can be securely obtained a sufficient crystalline property of the crystalline polyester resin segment.

As a diol component, it is preferable to use an aliphatic diol. It may be included a diol other than an aliphatic diol when needed. As an aliphatic diol, it is preferable to use a straight chain type. By using a straight chain type, it will have an advantage of improving crystalline property. The diol component may be used alone, or may be used in combination of two or more kinds.

Examples of an aliphatic diol are: ethylene glycol, 1,3-propanediol, 1,4-butanediol, 1,5-pentanediol, 1,6-hexanediol, 1,7-heptanediol, 1,8-octanediol, 1,9-nonanediol, 1,10-dodecanediol, 1,11-undecanediol, 1,12-dodecanediol, 1,13-tridecanediol, 1,14-tetradecanediol, 1,18-octadecanediol, and 1,20-eicosandiol.

Among aliphatic diols, preferable diol components are aliphatic diols of 2 to 12 carbon atoms. More preferable diols are aliphatic diols of 6 to 12 carbon atoms.

Diols other than aliphatic diols, which may be co-used according to necessity, are: diols having a double bond; and diols having a sulfonic acid group. Specific diols having a double bond are: 2-butene-1,4-diol, 3-hexene-1,6-diol, and 4-octene-1,8-diol.

As a diol component for forming a crystalline polyester resin segment, it is preferable that the content of the aliphatic diol is 50 mole % or more, more preferably 70 mole % or more, still more preferably 80 mole % or more, and most preferably 100 mole %. By making the content of the aliphatic diol in the diol component to be 50 mole % or more, it can be securely obtained a sufficient crystalline property of the crystalline polyester resin segment. At the same time, the produced toner will have excellent low-temperature fixability and the obtained final image will be provided with high glossiness.

Regarding the ratio of the diol component and the polycarboxylic acid component, it is preferred that the equivalent ratio of the hydroxy groups (OH) of the diol component to the carboxy groups (COOH) of the polycarboxylic acid component ([OH]/[COOH]) is in the range of 1.5/1 to 1/1.5, more preferably in the range of 1.2/1 to 1/1.2.

The preparation method of the crystalline polyester resin segment is not limited in particular. It may be produced by polycondensation (esterification) of the above-described polycarboxylic acid and polyhydric alcohol with a known esterification catalyst.

Usable catalysts for producing a crystalline polyester resin segment of the present invention are: alkali metal compounds made of sodium and lithium; alkali earth metal compounds made of magnesium and calcium; metal compounds made of metals such as aluminum, zinc, manganese, antimony, titanium, tin, zirconium, and germanium phosphorous acid compounds, phosphoric acid compounds, and amine compounds.

Specific examples of a tin compound are: dibutyltin oxide, tin octylate, tin dioctylate, and salts thereof. Specific examples of a titanium compound are: titanium alkoxides such as tetra-n-butyl titanate, tetraisopropyl titanate, tetramethyl titanate, and tetrastearyl titanate; titanium acylates such as polyhydroxy titanium stearate; and titanium chelates such as titanium tetraacetylacetonate, titanium lactate, and titanium triethanolaminate. A specific example of a germanium compound is germanium dioxide. Specific examples of an aluminum compound are: and oxide such as poly aluminum hydroxide, aluminum alkoxide, and tributyl aluminate.

These compounds may be used alone or in combination of two or more kinds.

The polymerization temperature is not limited in particular. A preferable polymerization temperature is in the range of 150 to 250° C. The polymerization time is not limited in particular. A preferable polymerization time is in the range of 0.5 to 10 hours. The inside pressure of the reaction system may be reduced when needed.

The content of each component segment in the hybrid resin may be determined with an NMR measurement or a measurement of Py-GC/MS of a methylation reaction, for example.

Here, the hybrid resin of the present invention contains the above-described crystalline polyester resin segment and an amorphous resin segment described in detail later. Although the hybrid resin of the present invention may be any form of a block copolymer or a graft copolymer as long as it contains both of a crystalline polyester resin segment and an amorphous resin segment, preferable is a graft copolymer. When the hybrid resin is a graft copolymer, it is easy to control the orientation of the crystalline polyester resin segment. Consequently, it is possible to give a sufficient crystalline property to the hybrid resin.

It is preferable that a crystalline polyester resin segment is grafted to a main chain of an amorphous resin segment. Namely, it is preferable that the hybrid crystalline polyester resin is a graft copolymer containing an amorphous resin segment as a main chain and a crystalline polyester resin segment as a side chain.

By making the above-described form, it can increase the orientation of the crystalline polyester resin segment. As a result, it is possible to improve the crystalline property of the hybrid resin. In addition, the hybrid resin may further include a substituent such as a sulfonic acid group, a carboxy group or a urethane group. The inclusion of the above-described group may be in the crystalline polyester resin segment or in the amorphous resin segment which will be described later.

### (Amorphous Resin Segment in Hybrid Resin)

The amorphous resin segment in the hybrid resin of the present invention is a portion derived from the amorphous resin other than the above-described crystalline polyester resin. The amorphous resin segment has a function to increase affinity of the hybrid resin with the amorphous resin which constitutes the binder resin. By the presence of the amorphous resin segment, the affinity of the hybrid resin with the amorphous resin will be improved. As a result, the hybrid resin will be easily incorporated in the amorphous resin, and electric-charging uniformity will be improved.

The incorporation of the amorphous resin segment into the hybrid resin (and in the toner) can be confirmed by determining a chemical structure with an NMR measurement or a measurement of Py-GC/MS of a methylation reaction, for example.

The amorphous resin segment is a resin segment that does not exhibit a melting point when a DSC measurement is done to the resin having the same chemical structure and molecular weight as the above-described amorphous resin segment. The amorphous resin segment has relatively high glass transition temperature (Tg). Here, it is preferable that the resin having the same chemical structure and molecular weight as the above-described amorphous resin segment has a glass transition temperature Tg1 (measured with DSC at a first temperature increasing step) in the range of 30 to 80° C., and more preferably in the range of 40 to 65° C.

The amorphous resin segment of the present invention is not limited in particular as long as it has the above-described structure. For example, a resin having a structure containing a main chain of an amorphous resin segment copolymerized with other component, or a resin having a structure containing a main chain of other component copolymerized with an amorphous resin segment is within the hybrid crystalline polyester resin of the preset invention as long as the toner contains a resin having an amorphous resin segment as described above.

It is preferable that the amorphous resin segment of the present invention is composed of the same kind of resin as the amorphous resin included in the binder resin (that is, a resin other than the hybrid resin). By making this embodiment, the affinity of the hybrid resin with the amorphous resin will be improved. As a result, the hybrid resin will be more easily incorporated in the amorphous resin, and electric-charging uniformity will be further improved.

Here, “the same kind of resin” indicates the resin in which a characteristic chemical bond is commonly included in the repeating unit. The meaning of “the characteristic chemical bond” is determined by “polymer classification” indicated in a database provided by National Institute for Material Science (NIMS): (http://polymer.nims.go.Jp/PoLyInfo/guide/jp/term_polymer.html). Namely, the chemical bonds which constitute the following 22 kinds of polymers are called as “the characteristic chemical bonds”: polyacryls, polyamides, polyacid anhydrides, polycarbonates, polydienes, polyesters, poly-halo-olefins, polyimides, polyimines, polyketones, polyolefins, polyethers, polyphenylenes, polyphosphazenes, polysiloxanes, polystyrenes, polysulfides, polysulfones, polyurethanes, polyureas, polyvinyls and other polymers.

“The same kind of resins” for the copolymer resins indicates resins having a common characteristic chemical bond in the chemical structure of a plurality of monomers which constitute the copolymer, when the copolymer has the monomers including the above-described chemical bonds as constituting units. Consequently, even if the resins each have a different property with each other, and even if the resins each have a different molar ratio of the monomers which constitute the copolymers, the resins are considered to be the same kind of resins as long as they contain a common characteristic chemical bond.

For example, the resin (or the resin segment) formed with styrene, butyl acrylate and acrylic acid and the resin (or the resin segment) formed with styrene, butyl acrylate and methacrylic acid both have at least a chemical bond constituting polyacrylate. Therefore, these two resins are the same kind of resins. Further examples are as follows. The resin (or the resin segment) formed with styrene, butyl acrylate and acrylic acid and the resin (or the resin segment) formed with styrene, butyl acrylate, acrylic acid, terephthalic acid, and fumaric acid both have at least a chemical bond constituting polyacrylate. Therefore, these two resins are also the same kind of resins.

The resin component that constitutes the amorphous resin segment is not limited in particular. Examples the resin component are: vinyl resin segment, urethane resin segment, and urea resin segment. Among them, the vinyl resin segment is preferably used, because it can easily control the thermoplastic property.

As a vinyl resin segment, any segments formed by polymerization of a vinyl monomer may be used without limitation. Examples of a vinyl resin segment are: acrylic acid ester resin segment, styrene-acrylic acid ester resin segment, and ethylene-vinyl acetate resin segment. These may be used alone, or may be used in combination of two or more kinds.

Among the above-described vinyl resin segments (amorphous resin segments), from the viewpoint of forming a fine domain structure having a uniform plasticizer, it is preferable to use a styrene-acrylic acid ester resin segment (styrene-acrylic resin segment). Therefore, it will be described the styrene-acrylic resin segment used as the amorphous resin segment in the following.

The styrene-acrylic resin segment is formed by polymerization of a styrene monomer and a (meth)acrylate monomer. Here, “the styrene monomer” includes: styrene having a structure of CH₂═CH—C₆H₅; and compounds having a known side chain or a functional group in the styrene structure. Further, “the (meth)acrylate monomer” includes: an acrylate compound represented by CH₂═CH—COOR (R: alkyl group) and a methacrylate compound; and compounds having a known side chain or a functional group in the acrylate compound and the methacrylate compound.

In the following, there will be described specific examples of a styrene monomer and a (meth)acrylate monomer that can form the styrene-acrylic resin segment. However, the compounds usable for the formation of the styrene-acrylic resin segment in the present invention are not limited to them.

Specific examples of a styrene monomer are: styrene, o-methylstyrene, m-methylstyrene, p-methylstyrene, α-methylstyrene, p-chlorostyrene, 3,4-dichlorostyrene, p-phenylstyrene, p-ethylstyrene, 2,4-dimethylstyrene, p-t-butylstyrene, p-n-hexylstyrene, p-n-octylstyrene, p-n-nonylstyrene, p-n-decylstyrene, and p-n-dodecylstyrene.

These styrene monomers may be used alone or may be used in combination of two or more kinds.

Specific examples of a (meth)acrylate monomer are: acrylate monomers such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate, and phenyl acrylate; and mehacrylate monomers such as methyl methacrylate, ethyl methacrylate, n-butyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate, and dimethylaminoethyl methacrylate.

In the present invention, the term “(meth)acrylate monomer” designates both “acrylate monomer” and “methacrylate monomer”. For example, “methyl (meth)acrylate” designates both “methyl acrylate” and “methyl methacrylate”.

These acrylate monomers and methacrylate monomers may be used solely or they may be used in combination of two or more kinds. That is, it is possible to form a copolymer using any one of combinations of: a styrene monomer and two or more kinds of acrylate monomers; a styrene monomer and two or more kinds of methacrylate monomers: and a styrene monomer, an acrylate monomer, and a methacrylate monomer.

A content of the constituting unit derived from the styrene monomer in the amorphous resin segment is preferably in the range of 40 to 90 mass % with respect to the total amount of the amorphous resin segment. A content of the constituting unit derived from the (meth)acrylate monomer in the amorphous resin segment is preferably in the range of 10 to 60 mass % with respect to the total amount of the amorphous resin segment. By making the content in the above-described range, it becomes easy to control the thermoplastic property of the hybrid resin.

Further, it is preferable that the amorphous resin segment is formed with other compound in addition to the styrene monomer and the (meth)acrylate monomer. This compound makes a chemical bond to the above-described crystalline polyester resin segment. Specifically, it is preferable to use a compound that forms an ester bond with a hydroxy group [—OH] originated from the polyhydric alcohol, or a carboxy group [—COOH]originated from the polycarboxylic acid in the above-described crystalline polyester resin segment. Therefore, it is preferable that the amorphous resin segment is formed with a compound capable of doing addition polymerization to the styrene monomer and the (meth)acrylate monomer, and containing a carboxy group [—COOH], or a hydroxy group [—OH] in the molecule.

Examples of these compounds are: compounds containing a carboxy group such as acrylic acid, methacrylic acid, maleic acid, itaconic acid, cinnamic acid, fumaric acid, maleic acid monoalkyl ester, and itaconic acid monoalkyl; and compounds containing a hydroxy group such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, 4-hydroxybutyl (meth)acrylate, and polyethylene glycol mono (meth)acrylate.

A content of the constituting unit derived from the above-described compound in the amorphous resin segment is preferably in the range of 0.5 to 20 mass % with respect to the total amount of the amorphous resin segment.

A forming method of a styrene-acrylic resin segment is not limited in particular. It can be cited a polymerization method to polymerize a monomer using a publicly known oil-soluble polymerization initiator or a water-soluble polymerization initiator. Specific examples of the oil-soluble polymerization initiator include the following azo-based or diazo-based polymerization initiators and peroxide-based polymerization initiators.

Azo-based or diazo-based polymerization initiators are such as 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, and azobisisobutyronitrile.

Peroxide-based polymerization initiators are such as benzoyl peroxide, methyl ethyl ketone peroxide, diisopropyl peroxycarbonate, cumene hydroperoxide, t-butyl hydroperoxide, di-t-butyl peroxide, dicumyl peroxide, 2,4-dichlorobenzoyl peroxide, lauroyl peroxide, 2,2-bis-(4,4-t-butylperoxycyclohexyl)propane, and tris-(t-butylperoxy)triazine.

When the resin particles are formed by the emulsion polymerization method, a water-soluble polymerization initiator can be used. Specific examples of the water-soluble polymerization initiator include: persulfates such as potassium persulfate and ammonium persulfate; azobisaminodipropane acetate; azobiscyanovaleric acid and salts thereof; and hydrogen peroxide.

A content of the amorphous resin segment is preferably in the range of 3 to less than 15 mass % based on the total amount of the hybrid resin. More preferably, it is in the range of 5 to less than 10 mass %, and still more preferably, it is in the range of 7 to less than 9 mass %. By setting this range, it is possible to impart sufficient crystallinity to the hybrid resin.

### (Production Method of Hybrid Resin)

A production method of a hybrid resin according to the present invention is not limited in particular as long as the production method can form a copolymer having a structure containing a molecular bond between the above-described crystalline polyester resin segment and the amorphous resin segment. A specific example of a production method of a hybrid resin is described in the following.

(1) A method for producing a hybrid resin having the following steps of: polymerizing an amorphous resin segment at first; and forming a crystalline polyester resin segment under the presence of the amorphous resin segment.

In this method, an amorphous resin segment is formed with an addition reaction of monomers constituting the above-described amorphous resin segment (preferably, vinyl monomers such as a styrene monomer and a (meth)acrylate monomer).

Subsequently, a polyhydric alcohol component and a polycarboxylic acid component are made to be polycondensed under the presence of the amorphous resin segment to form a crystalline polyester resin segment. During the moment in which a polyhydric alcohol component and a polycarboxylic acid component are made to be polycondensed, the polyhydric alcohol component or the polycarboxylic acid component is made to conduct an addition reaction to the amorphous resin segment. Thus, a hybrid resin is formed.

In the above-described method, it is preferable that the crystalline polyester resin segment and the amorphous resin segment each contain a portion where these two segments can react with each other.

Specifically, during the formation of the amorphous resin segment, in addition to the monomers constituting the amorphous resin segment, it is used a compound containing a portion which can react with a carboxy group [—COOH], or a hydroxy group [—OH] remained in the crystalline polyester resin segment and a portion which can react with the amorphous resin segment. That is, by the reaction of this compound with a carboxy group [—COOH], or a hydroxy group [—OH] remained in the crystalline polyester resin segment, the crystalline polyester resin segment can form a chemical bond with the amorphous resin segment.

Alternatively, during the formation of the crystalline polyester resin segment, it may be used a compound which can react with the polyhydric alcohol component or the polycarboxylic acid component, with the condition that this compound has a portion which can react with the amorphous resin segment.

By using the above-described method, it can form a hybrid resin having a structure of a molecular bond (a graft structure) of the amorphous resin segment bonded with the crystalline polyester resin segment.

(2) A method for producing a hybrid resin having the following steps of: respectively forming a crystalline polyester resin segment and an amorphous resin segment; and making to bond these two segments.

In this method, a polyhydric alcohol component and a polycarboxylic acid component are made to be polycondensed to form a crystalline polyester resin segment. Apart from a reaction system to form a crystalline polyester resin segment, an amorphous resin segment is formed by making an addition polymerization of monomers constituting the amorphous resin segment. During this reaction, it is preferable to incorporate portions which can be mutually reacted by the crystalline polyester resin segment and the amorphous resin segment. The method for incorporate such portions which can be reacted is the same as described above, therefore, the detailed explanation is omitted.

Subsequently, by reacting the above-described crystalline polyester resin segment with the amorphous resin segment, it can form a hybrid resin having a structure containing a molecular bond between the crystalline polyester resin segment and the amorphous resin segment.

When the above-described portions which can be reacted are not incorporated in the crystalline polyester resin segment and the amorphous resin segment, it may be formed a co-existing system of the crystalline polyester resin segment and the amorphous resin segment at first, then it may adopt a method of adding a compound having a portion which can be bonded to the crystalline polyester resin segment and the amorphous resin segment. It can from a hybrid resin having a structure containing a molecular bond between the crystalline polyester resin segment and the amorphous resin segment.

(3) A method for producing a hybrid resin having the following steps of: forming a crystalline polyester resin segment at first; and making polymerization reaction to form an amorphous resin segment under the presence of the crystalline polyester resin segment.

In this method, a polyhydric alcohol component and a polycarboxylic acid component are made to be polycondensed to form a crystalline polyester resin segment at first.

Subsequently, monomers constituting the amorphous resin segment are made to be polymerized to form the amorphous resin segment. During this reaction, in the same manner as in the above-described method (1), it is preferable to incorporate, in the crystalline polyester resin segment and the amorphous resin segment, portions which can be mutually reacted by the crystalline polyester resin segment and the amorphous resin segment. The method for incorporating such portions which can be reacted is the same as described above, therefore, the detailed explanation is omitted.

By using the above-described method, it can form a hybrid resin having a structure of a molecular bond (a graft structure) of the crystalline polyester resin segment bonded with the amorphous resin segment.

Among the production methods (1) to (3) as described above, the production method (1) is preferably used since this method enables to easily form a hybrid resin having a structure of an amorphous resin chain bonded with a crystalline polyester resin chain as a grafted portion, and this method can simplify the production method.

The production method (1) contains the steps of forming an amorphous resin segment at first, then making to bond a crystalline polyester resin segment. Consequently, the orientation of the crystalline polyester resin segment will be uniform. As a result, it can be securely formed a hybrid resin appropriate to the toner according to the present invention. This is a preferable embodiment.

### (Other Crystalline Resins)

Usable crystalline resins in the present invention are not limited to the above-described crystalline polyester resins and hybrid resins. Known crystalline resins may be used. Examples of the usable crystalline resins are: a crystalline polyurethane resin, a crystalline polyurea resin, a crystalline polyamide resin, and a crystalline polyether resin described in paragraphs [0056] to [0102] of JP-A No. 2015-011325.

### <Releasing Agent>

The releasing agent according to the present invention is not limited in particular, and known releasing agents can be used. Examples of the waxes include polyolefin waxes, such as polyethylene wax and polypropylene wax; branched hydrocarbon waxes, such as microcrystalline wax; long-chain hydrocarbon waxes, such as paraffin wax and SASOL wax; dialkyl ketone waxes, such as distearyl ketone; ester waxes, such as carnauba wax, montan wax, behenyl behenate, trimethylolpropane tribehenate, pentaerythritol tetrabehenate, pentaerythritol diacetate dibehenate, glycerol tribehenate, 1,18-octadecanediol distearate, tristearyl trimellitate, and distearyl maleate; and amide waxes, such as ethylenediaminebehenylamide and trimellitic tristearylamide.

As the release agent according to the present invention, it is preferable to use at least an ester wax or a hydrocarbon wax (branched chain hydrocarbon wax and long chain hydrocarbon wax) among the above-mentioned releasing agents. When these types of releasing agents are used, the releasing agent is encapsulated in the toner and becomes less likely to be exposed to the surface, thereby suppressing filming and lowering of the heat resistance of the toner. In addition, it is preferable to use these kinds of releasing agents from the viewpoint of securing thin paper separability (paper feeding property).

It is preferable that a content of the releasing agent in the toner particles is in the range of 2 to 30 mass %, more preferably, it is in the range of 5 to 20 mass % with respect to the total mass of the toner.

### [Color of Toner]

In the present invention, at least one of the two or more kinds of toners used is an achromatic color toner or a clear toner, and at least one type is a chromatic color toner containing a crystalline resin and a releasing agent.

Here, a “chromatic color toner” basically means a toner having three attributes of hue, lightness, and saturation, such as yellow toner, magenta toner and cyan toner. An “achromatic toner” basically means a toner which has no hue and saturation and has only lightness, such as black toner, white toner (also referred to as “white color toner”), and gray toner.

Among the achromatic toners, a white toner designates a toner having a color (white color) satisfying the following: the lightness L* is 80 or more; and a* and b* are −10≤a*≤10 and −10≤b*≤10 (white color) in the CIE L*a*b* color space, wherein the measurement is done for the case where only a white toner is transferred onto a transfer material, and its surface is measured with a spectral color difference meter in accordance with JIS Z 8781-4: 2013.

As an achromatic color toner, a white toner whose printing color is in the range of ((a*)²+(b*)²)^{0.5}≤5 in the CIE L*a*b* color space, or a gray toner or a black toner whose printing color is in the range of ((a*)²+(b*)²)^{0.5}≤5 in the CIE L*a*b* color space is preferably used.

It is also preferable that the white color of the white toner has L* in the range of 90 or more in the CIE L*a*b* color space. It is also preferable that the print color of the gray and black toner has L* in the range of 30 or less in the CIE L*a*b* color space.

A “clear toner” is a toner in which the layer formed of the clear toner transmits light in almost the entire visible light region or light in a partial region in an electrophotographic image, and achieving a so-called transparency state in which the opposite side of the layer can be seen through. The light transmittance is not particularly limited as long as the transmittance is such that it can be seen through, but it is 50% or more, preferably 70% or more, more preferably 90% or more. In addition, when light in almost the entire visible light region is transmitted, it becomes colorless and transparent.

As a clear toner, for example, a toner containing no colorant (e. g., coloring pigment, colored dye, black carbon particle, black magnetic powder) which shows coloration by the action of light absorption or light scattering can be mentioned. For example, it may be a toner containing a colorant such as a coloring pigment or a coloring dye in a small amount, or it may be a toner whose transparency is somewhat lowered depending on the type and addition amount of internal additives such as resin and releasing agent and external additives.

The clear toner appropriately covers the surface of a recording medium such as paper to smooth the surface of the recording medium to give gloss, to intentionally form irregularities on the surface of the recording medium to impart a mat feeling. By doing so, it realizes a visual effect which is a visual surface effect.

As described above, the term “color toner” as used in the present specification means a toner belonging to a toner group including a chromatic color toner and an achromatic color toner including a black toner and a gray toner. It is assumed that a white toner and a clear toner are not included in the color toner. That is, since most of the recording medium (for example, recording paper) normally used has a white color, this white color is used as a reference color, and the chromatic color toner, the black color and the gray toner which are recognized to be different from this white color will be referred to as a “color toner” for the sake of convenience.

### <Colorant>

Yellow colorants which may be used for a yellow toner are: C. I. Solvent Yellows 19, 44, 77, 79, 81, 82, 93, 98, 103, 104, 112, and 162; and C. I. Pigment Yellows 14, 17, 74, 93, 94, 138, 155, 180, and 185. The mixtures of these may be also used.

Magenta colorants which may be used for a magenta toner are: C. I. Solvent Reds 1, 49, 52, 58, 63, 111, and 122; and C. I. Pigment Reds 5, 48:1, 53:1, 57:1, 122, 139, 144, 149, 166, 177, 178, and 222. The mixtures of these may be also used.

Cyan colorants which may be used for a cyan toner are: C. I. Solvent Blues 25, 36, 60, 70, 93, and 95; C. I. Pigment Blues 1, 7, 15:3, 18:3, 60, 62, 66, and 76.

Orange colorants which may be used for an orange toner are: C. I. Solvent Oranges 63, 68, 71, 72, and 78; and C. I. Pigment Oranges 16, 36, 43, 51, 55, 59, 61, and 71.

Green colorants which may be used for a green toner are: C. I. Solvent Greens 3, 5, and 28; and C. I. Pigment Green 7.

Black colorants which may be used for a black toner are: a carbon black, a magnetic material, and iron-titanium oxide black. Usable examples of a carbon black are: channel black, furnace black, acetylene black, thermal black, and lamp black. Usable examples of a magnetic material are: ferrite and magnetite.

Examples of a colorant for the white toner include: inorganic pigments (for example, titanium white, zinc white, titanium strontium white, heavy calcium carbonate, light calcium carbonate, titanium dioxide, aluminum hydroxide, satin white, talc, calcium sulfate, barium sulfate, zinc oxide, magnesium oxide, magnesium carbonate, amorphous silica, colloidal silica, white carbon, kaolin, calcined kaolin, delaminated kaolin, aluminosilicate, sericite, bentonite, and smectite); and organic pigments (for example, polystyrene resin particles, and urea formalin resin particles).

Among these, in the present invention, titanium oxide of rutile type crystal and titanium oxide of anatase type crystal are preferable because of high whiteness. By using titanium oxide having a particle diameter in the range of 10 to 1000 nm, a white toner having high pigment dispersibility can be obtained, which is preferable.

With respect to the clear toner according to the present invention, it is preferable not to use the colorant as described above. Regarding the clear toner, reference is made to JP-A Nos. 2014-203056 and 2016-224229.

In order to stabilize the electrostatic characteristics of the toner, the electric resistivity of the pigment is preferably 1×10⁸ to 1×10¹² Ω·cm. A suitable toner electric resistivity may not be realized with a pigment having a higher resistivity than this range even if the resistivity is controlled by conductive fine particles which will be described later. Also, with a pigment having a lower resistivity than this range, the conductivity of the toner is increased and it is difficult to stabilize the electrostatic characteristics of the toner, which is not preferable. By treating the pigment surface with a silane coupling agent, a silicone oil, a fatty acid such as stearic acid, an alcohol, and an amine such as trimethanol amine, it is possible to easily achieve both extremely high pigment dispersibility and charge stability of the toner. The content ratio of the colorant in the toner particles is preferably from 0.5 to 20 mass %, more preferably from 2 to 10 mass %.

### [Production Method of Toner]

A production method of a toner (toner particles) according to the present invention is not limited in particular. It can be cited known polymerization methods such as: a suspension polymerization method, an emulsion polymerization aggregation method, and a dispersion polymerization method.

The toner particles according to the present invention may have a core-shell structure in which the surface of the core particle made of a core resin is covered with a shell layer made of a shell resin. It may have a monolayer structure. When a core-shell structure is used, it is preferable that the shell resin is an amorphous resin.

The obtained dried toner particles may be used directly as a toner. It may be added a known external additive to the toner particles by mixing under a dry condition. It is possible to use them as a toner.

For mixing the external additive, it may be used a various known mixing machines such as a turbular mixer, a Henschel mixer, a Nouter mixer, and a V-type mixer.

A method of producing a toner according to the present invention will be described by specifically describing a method of producing a yellow toner in the following. The method of producing the yellow toner is suitably applied to the methods of producing toners other than the yellow toner (for example, a magenta toner, a cyan toner, and a black toner) by changing the used colorant. The clear toner may be produced in the same manner as the color toner by not using a colorant in particular.

The method of producing a toner according to the present invention is not limited to the method described in the following.

### <Preparation of Aqueous Dispersion Liquid of Colorant Particles>

Sodium dodecyl sulfate was added to ion-exchanged water. To this was added a yellow colorant, and the mixture was subjected to a dispersion treatment. Thus, it was obtained an aqueous dispersion liquid of colorant particles of the yellow colorant.

### <Preparation of Aqueous Dispersion Liquid of Amorphous Vinyl Polymer Containing Releasing Agent>

### (First Stage Polymerization)

Into a reaction vessel equipped with a stirrer, a temperature sensor, a cooling tube and a nitrogen introducing device, sodium dodecyl sulfate and ion-exchanged water are charged. While stirring under nitrogen flow, the inner temperature is raised. After the temperature is raised, a solution of potassium persulfate dissolved in ion-exchanged water is added thereto, and a monomer mixture composed of the following is dropwise added: styrene (St) (as a styrene monomer); n-butyl acrylate (BA) (as an acrylate monomer); and methacrylic acid (MAA) (as a compound having a carboxy group [—COOH], or a hydroxy group [OH]). Then, the reaction system is heated and stirred to carry out the polymerization. A dispersion liquid of resin fine particles (1) is thus prepared.

### (Second Stage Polymerization)

Into a reaction vessel equipped with a stirrer, a temperature sensor, a cooling tube and a nitrogen introducing tube, a solution of sodium polyoxyethylene(2) dodecyl ether sulfate dissolved in ion-exchanged water is charged. After heating the solution, the above-described dispersion liquid (1) of the resin fine particles, a monomer mixture composed of: styrene (St) (a styrene monomer); n-butyl acrylate (BA) (a (meth)acrylate monomer); methacrylic acid (MAA) (a compound having a carboxy group [COOH] or a hydroxy group [OH]), n-octyl-3-mercapto propionate, and behenyl behenate (mp. 73° C.; a releasing agent) are added. The reaction system is mixed and dispersed so that a dispersion containing emulsion particles (oil particles) is prepared.

Then, an initiator solution of potassium persulfate dissolved in ion-exchanged water is added to the dispersion, and the system is heated and stirred to carry out polymerization. A dispersion liquid (2) of resin fine particles is thus prepared.

### (Third Stage Polymerization)

To the dispersion liquid (2) of resin fine particles is added ion-exchanged water, and the system is fully mixed. Then, a solution of potassium persulfate dissolved in ion-exchanged water is added thereto. A monomer mixture composed of: styrene (St) (a styrene monomer); n-butyl acrylate (BA) (a (meth)acrylate monomer); methacrylic acid (MAA) (a compound having a carboxy group [—COOH], or a hydroxy group [—OH]); and n-octyl-3-mercapto propionate, is added dropwise thereto. After addition, the system is heated and stirred to carry out the polymerization, and then the system is cooled. An aqueous dispersion liquid of an amorphous vinyl polymer containing a releasing agent is thus prepared.

### <Preparation of Aqueous Dispersion Liquid of Crystalline Polyester Resin>

### (Synthesis of Crystalline Polyester Resin)

Into a dropping funnel are placed raw material monomers for producing an addition polymerization resin segment (here, a styrene-acrylic resin segment is produced) and a radical polymerization initiator. For example, styrene, n-butyl acrylate, methacrylic acid, and di-tert-butyl peroxide (as a polymerization initiator) are placed in the dropping funnel.

Into a 4 necked reaction vessel equipped with a stirrer, a nitrogen introducing device, a temperature sensor, and a cooling tube are placed raw material monomers for producing a polycondensation resin segment (here, crystalline polyester resin segment is produced). For example, sebacic acid (an aliphatic dicarboxylic acid) and 1,12-dodecandiol (an aliphatic diol) are placed therein, and the mixture is heated to dissolve.

Subsequently, the raw material monomers for producing a polycondensation resin segment and a radical polymerization initiator in the dropping funnel are added dropwise with stirring. After conducting aging, the unreacted addition reaction monomers are removed under a reduced pressure.

Afterward, an esterification catalyst is added, and the temperature of the mixture is raised so that the system is reacted. Then, the reaction is further continued under the reduced pressure.

Subsequently, the mixture is cooled and the system is reacted under the reduced pressure. Thus, a hybrid resin of a crystalline polyester resin is obtained.

### (Preparation of Aqueous Dispersion Liquid of Crystalline Polyester Resin)

The crystalline polyester resin produced in the above-described synthetic example is dissolved in a solvent (such as methyl ethyl ketone) with stirring. Then, an aqueous solution of sodium hydroxide is added to the dissolved solution. While stirring the dissolved solution, water is dropwise added and mixed to prepare an emulsion.

Subsequently, by removing the solvent from this emulsion, it can be prepared an aqueous dispersion liquid in which the crystalline polyester resin is dispersed.

### <Preparation of Aqueous Dispersion Liquid of Amorphous Polyester Resin>

### (Preparation of Amorphous Polyester Resin)

Into a reaction vessel equipped with a nitrogen introducing tube, a dehydration tube, a stirrer, and a thermocouple are placed: a bisphenol A propylene oxide 2 mole adduct; tereplthalic acid; fumaric acid; and an esterification catalyst (for example, tin octylate). Then, a condensation polymerization reaction is conducted. The reaction is further conducted under the reduced pressure, and the reaction mixture is cooled. Subsequently, a monomer mixture composed of: methacrylic acid (MAA) (a compound having a carboxy group [—COOH], or a hydroxy group [—OH]); styrene (St); (a styrene monomer); and n-butyl acrylate (BA) (a (meth)acrylate monomer), and a polymerization initiator (for example, di-tert-butyl peroxide) are dropwise added. After addition, an addition polymerization reaction is conducted, then the temperature of the reaction mixture is raised and the temperature is kept under the reduced pressure. Subsequently, the compound having a carboxy group [—COOH], or a hydroxy group [—OH], the styrene monomer, and the (meth)acrylate monomer are removed to synthesize an amorphous polyester resin having a vinyl resin segment and a crystalline polyester segment bonded with each other.

### (Preparation of Aqueous Dispersion Liquid of Amorphous Polyester Resin)

The amorphous polyester resin produced in the above-described synthetic example is dissolved in a solvent (such as methyl ethyl ketone) with stirring. Then, an aqueous solution of sodium hydroxide is added to the dissolved solution. While stirring the dissolved solution, water is dropwise added and mixed to prepare an emulsion.

Subsequently, by removing the solvent from this emulsion, it can be prepared an aqueous dispersion liquid in which the amorphous polyester resin is dispersed.

### <Preparation of Yellow Toner>

Into a reaction vessel equipped with a stirrer, a temperature sensor and a cooling tube, an aqueous dispersion liquid of an amorphous vinyl polymer containing a releasing agent and ion-exchanged water are charged. Thereafter, the pH is adjusted by adding an aqueous sodium hydroxide solution.

Thereafter, an aqueous dispersion liquid of colorant fine particles is added thereto. Then, while stirring, an aqueous solution of magnesium chloride is added. The temperature of the system is raised, and an aqueous dispersion liquid of a crystalline polyester resin is added to allow the particle growth reaction to continue. At the moment when the particle size becomes to a required value, an aqueous dispersion liquid of an amorphous polyester resin is added. Then, an aqueous solution made of sodium chloride dissolved in ion-exchanged water is added to terminate the particle growth. Then, the reaction system is further heated and stirred to allow fusion of the particles to proceed. Afterwards, the system is cooled.

Then, solid-liquid separation is carried out, and a dewatered toner cake is washed. Thereafter, the toner cake is dried to yield yellow toner particles. By adding an external additive to the obtained toner particles, a yellow toner is prepared.

### (Preparation Method of Yellow Developer)

A yellow developer is prepared by adding a known ferrite carrier to the above-described yellow toner.

The applicable embodiments of the present invention are not limited to the embodiments described-above. They may be suitably changed within the scope of not exceeding the object of the present invention. The scope of the present invention should be interpreted by terms of the appended claims.

### EXAMPLES

Hereinafter, specific examples of the present invention will be described by referring to specific examples, but the present invention is not limited thereto.

### <Preparation of Toner and Developer>

### [Synthesis of Crystalline Polyester Resin and Preparation of its Dispersion Liquid C1]

### (Synthesis of Crystalline Polyester Resin)

Raw material monomers for a styrene-acrylic (StAc) polymerization segment including a bi-reactive monomer and a radical polymerization initiator as described below were loaded in a dropping funnel.

| | |
|---|---|
| Styrene (St): | 36.0 mass parts |
| n-Butyl acrylate (BA): | 13.0 mass parts |
| Acrylic acid (Ac): | 2.0 mass parts |
| Di-t-butylperoxide (polymerization initiator): | 7.0 mass parts |

Further, raw material monomers for a crystalline polyester (CPEs) polymerization segment described below were introduced in a four-necked flask equipped with a nitrogen introducing device, a dehydration tube, a stirrer, and a thermocouple. Then, the mixture was heated to 170° C. to dissolve the content.

| | |
|---|---|
| Tetradecanedioic acid | 440 mass parts |
| 1,4-Butanediol | 153 mass parts |

Subsequently, the raw material monomers for a styrene-acrylic (StAc) polymerization segment was dropped over a period of 90 minutes, and an aging reaction was done for 60 minutes. Then, the unreacted raw material monomers were removed under a reduced pressure (8 kPa).

The amount of the removed monomers was very small compared with the raw monomers loaded. Then, 0.8 mass parts of T(OBu)₄ were added as an esterification catalyst, and the mixture was heated to 235° C. The reaction was carried out under a normal pressure (101.3 kPa) for 5 hours, then further the reaction was made under a reduced pressure (8 kPa) for 1 hour.

Subsequently, the reaction mixture was cooled to 200° C., and the reaction was made under a reduced pressure (20 kPa) for 1 hour. Thus, a crystalline polyester resin (hybrid crystalline polyester resin) was obtained. The crystalline polyester resin thus obtained had an acid value of 20.9, a weight average molecular weight (Mw) of 25.200, a melting point (Tm) of 74.9° C. and a recrystallization temperature (Rc) of 69.7° C.

### (Preparation of Crystalline Polyester Resin Particle Dispersion Liquid C1)

72 mass parts of the above-described crystalline polyester resin were added to 72 mass parts of methyl ethyl ketone and the mixture was stirred at 70° C. for 30 minutes to dissolve. Then, 3.0 mass parts of 25 mass % of aqueous sodium hydroxide solution was added thereto. This solution was placed in a reaction vessel having a stirrer and 252 mass parts of water warmed to 70° C. were dropped and mixed over a period of 70 minutes while stirring. In the course of the dropwise addition, the liquid in the vessel became cloudy, and after the whole amount was dropped, a uniform emulsified state was obtained.

Subsequently, while keeping this emulsion at 70° C., the reaction mixture was stirred for 3 hours under a reduced

pressure of 15 kPa (150 mbar) by using a diaphragm vacuum pump “V-700” (manufactured by BUCHI, Co. Ltd.). During this step, methyl ethyl ketone was removed to prepare an aqueous dispersion liquid C1 of crystalline polyester resin. As a result of measurement with a particle size distribution measuring instrument, the particles included in the dispersion liquid C1 had a volume average particle diameter of 110 nm.

### (Preparation of Crystalline Polyester Resin Particle Dispersion Liquids C2 and C3)

The crystalline polyester resin particle dispersions C2 and C3 were prepared in the same manner as preparation of the crystalline polyester resin particle dispersion C1, except that the addition amount of the 25 mass % sodium hydroxide aqueous solution was changed as indicated in Table I.

TABLE 1

| Crys- | | | | | | | |
|---|---|---|---|---|---|---|---|
| talline | | | | | | | |
| poly- | | | | | | | |
| ester | | | | | | | |
| resin | Added amount (mass parts) | | | | | | Disper- |
| particle | | | 25 mass % | | Desolvation | | sion |
| disper- | Crys- | | sodium | | treatment | | result |
| sion | talline | Methyl | hydroxide | | Pres- | Stirring | Median |
| liquid | poly- | ethyl | aqueous | | sure | time | diameter |
| No. | ester | ketone | solution | Water | (kPa) | (hours) | (nm) |
| C1 | 72 | 72 | 3.0 | 252 | 15 | 3 | 110 |
| C2 | 72 | 72 | 2.5 | 252 | 15 | 3 | 280 |
| C3 | 72 | 72 | 2.0 | 252 | 15 | 3 | 460 |

### [Preparation of Vinyl Resin Particle Dispersion Liquid 1 for Core Particle]

### (First Stage Polymerization)

Into a 5 L reaction vessel equipped with a stirrer, a temperature sensor, a cooling tube, and a nitrogen introducing device, 8 mass parts of sodium lauryl sulfate and 3,000 mass parts of ion-exchanged water were charged. While stirring at a stirring speed of 230 rpm under a nitrogen flow, the inner temperature of the reaction vessel was raised to 80° C. After raising the temperature, a solution of 10 mass parts of potassium persulfate dissolved in 200 mass parts of ion-exchanged water was added thereto, and the liquid temperature was raised again to 80° C. A mixed solution of the following monomer mixture was added dropwise to this solution over a period of 1 hour.

| | |
|---|---|
| Styrene (St): | 480.0 mass parts |
| n-Butyl acrylate (BA): | 250.0 mass parts |
| Methacrylic acid (MAA): | 68.0 mass parts |

After dropping the mixture, the reaction system was heated and stirred at 80° C. for 2 hours to carry out the polymerization. Thus, a vinyl resin particle dispersion liquid (1-a) was prepared.

### (Second Stage Polymerization)

Into a 5 L reaction vessel equipped with a stirrer, a temperature sensor, a cooling tube, and a nitrogen introducing device, a solution of 7.0 mass parts of sodium polyoxyethylene (2) dodecyl ether sulfate dissolved in 3,000 mass parts of ion-exchanged water was charged. The solution was heated to 98° C. After heating, 80 mass parts in terms of solid content of the vinyl resin particle dispersion liquid (1-a) prepared by the first stage polymerization, a mixed solution obtained by dissolving the following monomers, a chain transfer agent and a releasing agent at 90° C. was mixed.

| | |
|---|---|
| Styrene (St): | 85.0 mass parts |
| n-Butyl acrylate (BA): | 95.0 mass parts |
| Methacrylic acid (MAA): | 20.0 mass parts |
| n-Octyl-3-mercaptopropionate (chain transfer agent): | 1.5 mass parts |
| Behenyl behenate (releasing agent, m.p. 73° C.): | 90.0 mass parts |

The reaction system was mixed and dispersed for 1 hour by using a mechanical disperser with a circulation route “CLEARMIX” (manufactured by M Technique Co., Ltd.) so that a dispersion liquid containing emulsion particles (oil particles) was prepared. Then, an initiator solution prepared by dissolving 6.0 mass parts of potassium persulfate in 200 mass parts of ion-exchanged water was added to the dispersion liquid, and the system was heated and stirred at 84° C. for 1 hour to carry out polymerization. Thereby a vinyl resin particle dispersion liquid (1-b) was prepared.

### (Third Stage Polymerization)

400 mass parts of ion-exchanged water was further added to the vinyl resin particle dispersion liquid (I-b) obtained by the second stage polymerization and mixed thoroughly. Then, a solution of 11.0 mass parts of potassium persulfate dissolved in 400 mass parts of ion-exchanged water was added. Further, under the temperature condition of 82° C. a mixed solution of the following monomers and a chain transfer agent was added dropwise over a period of 1 hour.

| | |
|---|---|
| Styrene (St): | 454.8 mass parts |
| 2-Ethylhexylhexyl acrylate (2EHA): | 143.2 mass parts |
| Methacrylic acid (MAA): | 52.0 mass parts |
| n-Octyl-3-mercapto propionate: | 8.0 mass parts. |

After completion of the addition, the solution was heated with stirring for 2 hours to carry out polymerization. After cooling to 28° C., a vinyl resin particle dispersion liquid 1 for forming a core was prepared. The vinyl resin 1 in the dispersion liquid had a weight average molecular weight (Mw) of 31,000, and a glass transition temperature (Tg) of 49° C. The vinyl resin particles in the dispersion liquid had a volume-based median diameter of 230 nm.

### [Synthesis of Amorphous Polyester Resin for Shell Layer and Preparation of its Dispersion Liquid S1]

### (Synthesis of Amorphous Polyester Resin for Shell Layer)

Raw material monomers for a styrene-acrylic polymerization segment (StAc) including a bi-reactive monomer and a radical polymerization initiator as described below were loaded in a dropping funnel.

| | |
|---|---|
| Styrene (St): | 80.0 mass parts |
| n-Butyl acrylate (BA): | 20.0 mass parts |
| Acrylic acid (Ac): | 10.0 mass parts |
| Di-t-butylperoxide (polymerization initiator): | 16.0 mass parts |

Further, raw material monomers for an amorphous polyester polymerization segment (APEs) described below were introduced in a four-necked flask equipped with a nitrogen introducing device, a dehydration tube, a stirrer, and a thermocouple. Then, the mixture was heated to 170° C. to dissolve the content.

| | |
|---|---|
| Bisphenol A propylene oxide 2 mol adduct: | 200.0 mass parts |
| Bisphenol A ethylene oxide 2 mol adduct: | 85.7 mass parts |
| Terephthalic acid: | 66.9 mass parts |
| Fumaric acid: | 47.4 mass parts |

Under stirring, the mixed solution in the dropping funnel was dropped into a four-necked flask over a period of 90 minutes, aged for 60 minutes, and unreacted monomers were removed under reduced pressure (8 kPa). Thereafter, 0.4 mass parts of Ti (OBu)₄ as an esterification catalyst were added, and the temperature was raised to 235° C. The reaction was carried out under atmospheric pressure (101.3 kPa) for 5 hours, and then under reduced pressure (8 kPa) for 1 hour. Subsequently, the reaction mixture was cooled to 200° C., the reaction was carried out under reduced pressure (20 kPa), and then desolvation was carried out to obtain an amorphous polyester resin s1 for shell layer (hybrid amorphous polyester resin). The obtained amorphous polyester resin for shell layer had an acid value of 18.8, a weight average molecular weight (Mw) of 25,000, and a glass transition temperature (Tg) of 60° C.

### (Preparation of Amorphous Polyester Resin Particle Dispersion Liquid S1 for Shell Layer)

72 mass parts of the above-described amorphous polyester resin were added to 72 mass parts of methyl ethyl ketone and the mixture was stirred at 70° C. for 30 minutes to dissolve. Then, 3.0 mass parts of 25 mass % of aqueous sodium hydroxide solution was added thereto. This solution was placed in a reaction vessel having a stirrer, and 252 mass parts of water warmed to 70° C. were dropped and mixed over a period of 70 minutes while stirring. In the course of the dropwise addition, the liquid in the vessel became cloudy, and after the whole amount was dropped, a uniform emulsified state was obtained.

Subsequently, while keeping this emulsion at 70° C., the reaction mixture was stirred for 3 hours under a reduced pressure of 15 kPa (150 mbar) by using a diaphragm vacuum pump “V-700” (manufactured by BUCHI, Co. Ltd.). During this step, methyl ethyl ketone was removed to prepare an amorphous polyester resin particle dispersion liquid S1 for shell layer. As a result of measurement with a particle size distribution measuring instrument, the particles included in the dispersion liquid S1 had a volume average particle diameter of 92 nm.

### [Preparation of Colorant Particle Dispersion Liquid]

While stirring a solution of 90 mass parts of sodium lauryl sulfate added to 1,600 mass parts of ion-exchanged water, 420 mass parts of copper phthalocyanine (C.I. Pigment Blue 15:3) were gradually added. And the mixture was dispersed using a stirring apparatus “CLEAR MIX” (manufactured by M Technique, Co., Ltd.) to prepare a dispersion liquid of colorant particles. The volume-based median diameter of the colorant particles in the dispersion liquid was found to be 110 nm.

### EXAMPLES AND COMPARATIVE EXAMPLES

### (Preparation of Cyan Toner 1)

Into a reaction vessel equipped with a stirrer, a temperature sensor and a cooling tube, 285 mass parts (in terms of solid content) of the vinyl resin particle dispersion liquid 1 for core particle, 40 mass parts (in terms of solid content) of the crystalline polyester resin particle dispersion liquid C1, 1 mass % of sodium dodecyl diphenyl ether disulfonate with respect to the resin (in terms of solid content) and 2,000 mass parts of ion-exchanged water were charged. The pH was adjusted to 10 by adding 5 mol/L sodium hydroxide aqueous solution at room temperature (25° C.).

Further, 30 mass parts (in terms of solid content) of the colorant particle dispersion liquid were added, and a solution prepared by dissolving 60 mass parts of magnesium chloride in 60 mass parts of ion-exchanged water was added at 30° C. over a period of 10 minutes with stirring. After standing for 3 minutes, the mixture was heated to 80° C. over a period of 60 minutes. After reaching 80° C., the stirring speed was adjusted so that the growth rate of the particle diameter became 0.01 μm/min, and the particles were grown until the volume-based median diameter measured by Coulter Multisizer 3 (manufactured by Beckman Coulter, Inc.) became 5.7 μm. Subsequently, 37 parts by mass (in terms of solid content) of amorphous polyester resin particle dispersion liquid S1 for shell layer was added over a period of 30 minutes. When the supernatant of the reaction solution became transparent, an aqueous solution prepared by dissolving 190 mass parts of sodium chloride in 760 mass parts of ion-exchanged water was added to stop the growth of the particle size.

Next, the temperature was elevated and agitated at 80° C., and fusion of the particles was allowed to proceed until the average degree of circularity of the toner mother panicles reached 0.970 (measured by “FPIA-3000” made by Sysmex Co. Ltd.), and then cooled to lower the liquid temperature to 30° C. at a cooling rate of 2.5° C./min. Then, solid-liquid separation was carried out, and a dewatered toner cake was washed by repeating re-dispersion in ion-exchanged water and solid-liquid separation for 3 times. Thereafter, the toner cake was dried at 40° C. for 24 hours to yield toner mother particles.

To 100 mass parts of the obtained toner mother particles, 0.6 mass parts of hydrophobic silica particles (number average primary particle size=12 nm, hydrophobicity=68), 1.0 mass parts of hydrophobic titanium oxide particles (number average primary particle size=20 nm, hydrophobicity=63), and 1.0 mass part of sol-gel silica particles (number average primary particle size=110 nm) were added. The composite was mixed at 32° C. for 20 minutes by using a “Henschel mixer” (Nippon Coke & Engineering, Co., Ltd.) in the condition of a rotary blade circumferential speed of 35 mm/sec. After mixing coarse particles were removed using a sieve having an opening of 45 μm to obtain a cyan toner 1. The obtained cyan toner 1 had a volume-based median diameter of 5.6 μm.

### (Preparation of Cyan Toners 2 to 6)

Cyan toners 2 to 6 were prepared in the same manner as preparation of the cyan toner 1 except that the added amount of the vinyl resin particle dispersion liquid 1 for core particle, and the kind and the amount (in terms of solid content) of the crystalline resin particle dispersion liquid were changed as described in Table II.

TABLE II

| | Added amount of resin dispersion liquid | | | | |
|---|---|---|---|---|---|
| | (in terms of solid content) | | | | |
| | Crystalline | | | | Crystalline |
| | polyester resin | | Vinyl | | polyester |
| | particle dispersion | | resin | Amorphous | domain |
| | liquid | | (mass | polyester | diameter |
| Cyan toner | No. | (mass parts) | parts) | (mass parts) | (μm) |
| Cyan toner 1 | C1 | 40 | 285 | 37 | 0.40 |
| Cyan toner 2 | C2 | 40 | 285 | 37 | 0.82 |
| Cyan toner 3 | C3 | 40 | 285 | 37 | 1.10 |
| Cyan toner 4 | C1 | 20 | 315 | 37 | 0.37 |
| Cyan toner 5 | C1 | 100 | 225 | 37 | 0.55 |
| Cyan toner 6 | — | — | 325 | 37 | — |

### (Preparation of Cyan Developers 1 to 6)

A carrier (ferrite carrier with volume-based median diameter=60 μm) coated with a silicone resin was added to the cyan toners 1 to 6 as prepared above so that the toner content (toner concentration) in the two-component developer became 6 mass %. The composite was mixed, and cyan developers 1 to 6 were prepared.

### <Preparation of White Toner 1>

3 mass parts of tricalcium phosphate were added to 900 mass parts of ion-exchanged water heated to 70° C., and the mixture was stirred at 10000 rpm using a TK type homomixer (manufactured by PRIMIX Corporation) to obtain an aqueous medium. The following materials were uniformly dispersed and mixed using an Attritor (manufactured by Nippon Coke & Engineering Co., Ltd.) to prepare a polymerizable monomer composition.

| | |
|---|---|
| Styrene (St): | 80.0 mass parts |
| n-Butyl acrylate (BA): | 20.0 mass parts |
| Divinylbenzene: | 1.0 mass part |
| Amorphous polyester resin: | 4.5 mass parts |

(Polycondensation product of Bisphenol A propylene oxide adduct and isophthalic acid, glass transition temperature=65° C., number average molecular weight (Mn)=17000, a ratio of weight average molecular weight (Mw)/number average molecular weight (Mn)=2.4)

| | |
|---|---|
| Aluminum salicylate (BONTRON E-88, made by Orient | 1.0 mass part |
| Chemical Industries Co. Ltd.): | |
| Titanium oxide: | 6.0 mass parts |

The obtained polymerizable monomer composition was heated to 63° C., then 9 mass parts of ester wax mainly composed of stearyl stearate were added thereto, mixed and dissolved. To this mixture were added 3 mass parts of 2,2′-azobis-2-methylbutyronitrile (as a polymerization initiator) and dissolved to obtain a polymerizable monomer mixture.

The polymerizable monomer mixture obtained above was added to the aqueous medium and stirred for 7 minutes at 10,000 rpm in a TK Homomixer under N₂ atmosphere at 63° C. so as to granulate the content. Thereafter, the mixture was reacted at 63° C. for 6 hours while stirring the mixture with a paddle stirring blade. Thereafter, the liquid temperature was set to 80° C., and stirring was continued for further 4 hours. After completion of the reaction, the reaction mixture was cooled, and hydrochloric acid was added to the suspension cooled to room temperature (25° C.) to dissolve the calcium phosphate salt, followed by filtration and washing with water to obtain wet toner mother particles. Next, the toner mother particles were dried at 40° C. for 12 hours to obtain white toner mother particles having a volume-based median diameter of 7.6 μm and an average circularity of 0.971. 100 mass parts of the white toner mother particles and 0.7 mass parts of a hydrophobic silica fine powder treated with a silicone oil having a BET value of 200 m²/g and an average primary particle diameter of 12 nm were mixed with a Henschel mixer (manufactured by Nippon Coke & Engineering Co., Ltd.) to obtain a white toner 1. The storage elastic modulus G1′ of the white toner 1 at 90° C. was 8.30×10⁵ dyn/cm².

### <Preparation of White Toner 2>

A white toner 2 was prepared in the same manner as preparation of the white toner 1 except that the used amount of divinylbenzene was changed to 0.5 mass parts. The storage elastic modulus G1′ of the white toner 2 at 90° C. was 5.83×10² dyn/cm².

### <Preparation of White Developers 1 and 2>

A ferrite carrier (ferrite carrier with volume-based median diameter=30 μm) coated with a copolymer resin of cyclohexyl methacrylate and methyl methacrylate (monomer mass ratio=1:1) was added to the white toners 1 and 2 so that the respective toner content in the developer became 6 mass %. The composite was mixed, and white developers 1 and 2 were prepared.

### (Fixing Device)

For the image forming apparatus and the fixing device the apparatuses illustrated in FIG. 1 and FIG. 2 were used (refer to JP-A 2005-43532). In addition, the following members were used for the rotating member in contact with the fixing rotating body and the cleaning member for cleaning the surface of the rotating member.

Rotating member: Aluminum A 5052 cylindrical core metal with a core metal thickness of 1.0 mm was hard anodized to form an alumina coating of about 40 μm. Further, secondary electrolysis was carried out in ammonium tetrathiomolybdate solution to precipitate molybdenum disulfide in the ultrafine pores in the coating film. Then the surface was polished to make the surface roughness Rz of the part in contact with the fixing rotating body to be 0.8 μm, the Vickers hardness 360 kg/mm², and having an outer diameter of 24 mm.

Cleaning member: A sheet-like web was used for the cleaning member. The web was stretched with tension between the original winding side and the winding side. The rotating member was disposed so as to abut against the web. Using the drive motor, the web on the take-up side of the sheet-like web was rotated by a predetermined angle to move the web. The rotating member was cleaned to move the dirty portion so as not to accumulate dirt. The web was a nonwoven fabric obtained by combining aromatic polyamide fiber and polyester fiber at a mass ratio of 6:4, having a thickness of 70 μm and a basis weight of 27 g/m².

### Examples 1 to 8 and Comparative Examples 1 to 7

Examples 1 to 8 and Comparative Examples 1 to 7 in which a white toner and a color toner other than white as indicated in Table III below were combined, and they were evaluated for low-temperature fixability and prevention property of mixed color contamination as described below.

### [Evaluation Method]

### <Low-Temperature Fixability>

For the two-component developers of Examples 1 to 6 and Comparative Examples 1 to 6, glossy paper “POD Gloss Coat 128 (128 g/m²) (Oji Paper Co., Ltd.)” was used by employing the image forming apparatus and the fixing apparatus illustrated in FIG. 1 and FIG. 2. Image formation was carried out with a white toner having a white toner adhesion amount listed in Table II on the paper and a cyan toner having a cyan toner adhesion n amount listed in Table II. The formed image was thermally fixed with conditions of a nip width of 11.2 mm, a fixing time of 34 msec, a fixing pressure of 133 kPa, a system speed of 230 mm/sec, and a fixing temperature of 150° C. In other words, the color toner other than the white toner and the white toner were thermally fixed at the same time. The printed matter was folded so as to apply a load to the solid image with a folding machine, and compressed air of 0.35 MPa was blown there, and the crease was ranked in four stages shown in the following evaluation criteria. The image having a rank of ⊚ or ∘ is considered to be acceptable for practical use. The images having ranks of ⊚ and ∘ pass examination. The same evaluation was carried out by changing the combination of toners to be used as indicated in Table II. The evaluation results are indicated in Table III.

[Evaluation Criteria]

⊚: No crease at all (no crease is generated in a cyan image or a white image)

◯: Partially peeling according to the crease is found but without problems for practical use (occasionally a white image can be seen under a crack of a cyan image, but no problem level)

Δ: There is a thick linear peeling according to the crease.

X: There is a large peeling.

### <Prevention Property of Mixed Color Contamination>

1000 sheets were outputted under the above evaluation condition of low-temperature fixability. Thereafter, glossy paper “POD Gloss Coat 128 (128 g/m²) (Oji Paper Co., Ltd.)” was used to form an image on the paper with a white toner adhesion amount of 8 g/m². The formed image was thermally fixed with conditions of a nip width of 11.2 mm, a fixing time of 34 msec, a fixing pressure of 133 kPa, a system speed of 230 mm/sec, and a fixing temperature of 150° C. By visually evaluating this image, mixed color contamination was visually evaluated. The evaluation criteria are as follows, and it is practically usable if it is ⊚ or ∘. The evaluation results are indicated in Table III.

[Evaluation Criteria]

⊚: There is no mixed color contamination of the cyan toner on the white image.

◯: Compared to images without mixed color contamination, slight cyan taint is observed, but with a level of no problem

Δ: Even if it is not compared with an image without mixed color contamination, it is recognized as cyan color.

X: Perfectly recognized as a cyan color.

TABLE III

| | | | | | Fixing | | Evaluation | |
|---|---|---|---|---|---|---|---|---|
| | | | | | constitution | | Prevention | |
| | | | | | Cleaning | | property | |
| | Toner constitution | | | | rotating | | of | |
| | Cyan toner | | White toner | | roller, | | mixed | Low- |
| | | Adhesion | | Adhesion | Present | | color | temper- |
| | | amount | | amount | or | Cleaning | contami- | ature |
| | Kind | (g/m²) | Kind | (g/m²) | Absent | member | nation | fixability |
| Example 1 | Cyan | 8.0 | White | 8.0 | Present | Present | ⊚ | ◯ |
| | toner 1 | | toner 1 | | | (for | | |
| | | | | | | cleaning | | |
| | | | | | | rotating | | |
| | | | | | | roller) | | |
| Example 2 | Cyan | 8.0 | White | 8.0 | Present | Present | ⊚ | ⊚ |
| | toner 2 | | toner 1 | | | (for | | |
| | | | | | | cleaning | | |
| | | | | | | rotating | | |
| | | | | | | roller) | | |
| Example 3 | Cyan | 8.0 | White | 8.0 | Present | Present | ⊚ | ⊚ |
| | toner 3 | | toner 1 | | | (for | | |
| | | | | | | cleaning | | |
| | | | | | | rotating | | |
| | | | | | | roller) | | |
| Example 4 | Cyan | 8.0 | White | 8.0 | Present | Present | ⊚ | ⊚ |
| | toner 4 | | toner 1 | | | (for | | |
| | | | | | | cleaning | | |
| | | | | | | rotating | | |
| | | | | | | roller) | | |
| Example 5 | Cyan | 8.0 | White | 8.0 | Present | Present | ⊚ | ⊚ |
| | toner 5 | | toner 1 | | | (for | | |
| | | | | | | cleaning | | |
| | | | | | | rotating | | |
| | | | | | | roller) | | |
| Example 6 | Cyan | 8.0 | White | 8.0 | Present | Present | ⊚ | ⊚ |
| | toner 5 | | toner 1 | | | (for | | |
| | | | | | | cleaning | | |
| | | | | | | rotating | | |
| | | | | | | roller) | | |
| Example 7 | Cyan | 8.0 | White | 8.0 | Present | Present | ⊚ | ◯ |
| | toner 1 | | toner 1 | | | (for | | |
| | | | | | | cleaning | | |
| | | | | | | rotating | | |
| | | | | | | roller) | | |
| Example 8 | Cyan | 13.0 | White | 13.0 | Present | Present | ⊚ | ⊚ |
| | toner 1 | | toner 1 | | | (for | | |
| | | | | | | cleaning | | |
| | | | | | | rotating | | |
| | | | | | | roller) | | |
| Comparative | Cyan | 8.0 | White | 8.0 | Present | Present | ⊚ | X |
| example 1 | toner 6 | | toner 1 | | | (for | | |
| | | | | | | cleaning | | |
| | | | | | | rotating | | |
| | | | | | | roller) | | |
| Comparative | Cyan | 8.0 | White | 8.0 | Absent | Present | Δ | ⊚ |
| example 2 | toner 1 | | toner 1 | | | (for | | |
| | | | | | | cleaning | | |
| | | | | | | rotating | | |
| | | | | | | roller) | | |
| Comparative | Cyan | 8.0 | White | 8.0 | Absent | Absent | X | ⊚ |
| example 3 | toner 1 | | toner 1 | | | | | |
| Comparative | Cyan | 8.0 | White | 8.0 | Absent | Present | Δ | X |
| example 4 | toner 6 | | toner 1 | | | (for | | |
| | | | | | | fixing | | |
| | | | | | | rotating | | |
| | | | | | | roller) | | |
| Comparative | Cyan | 8.0 | White | 8.0 | Absent | Absent | X | X |
| example 5 | toner 6 | | toner 1 | | | | | |
| Comparative | Cyan | 3.0 | White | 3.0 | Present | Present | X | X |
| example 6 | toner 1 | | toner 1 | | | (for | | |
| | | | | | | cleaning | | |
| | | | | | | rotating | | |
| | | | | | | roller) | | |
| Comparative | Cyan | 17.0 | White | 17.0 | Present | Present | X | ⊚ |
| example 7 | toner 1 | | toner 1 | | | (for | | |
| | | | | | | cleaning | | |
| | | | | | | rotating | | |
| | | | | | | roller) | | |

As is apparent from the evaluation results indicated in Table III, in Examples according to the present invention, mixed color contamination is prevented compared to the comparative examples, and low-temperature fixability is also excellent.

### Example: Evaluation 2

### <Preparation of Clear Toner 1>

3 mass parts of tricalcium phosphate were added to 900 mass parts of ion-exchanged water heated to 70° C., and the mixture was stirred at 10000 rpm using a TK type homomixer (manufactured by PRIMIX Corporation) to obtain an aqueous medium. The following materials were uniformly dispersed and mixed using an Attritor (manufactured by Nippon Coke & Engineering Co., Ltd.) to prepare a polymerizable monomer composition.

| | |
|---|---|
| Styrene (St): | 80.0 mass parts |
| n-Butyl acrylate (BA): | 20.0 mass parts |
| Divinylbenzene: | 1.0 mass part |
| Amorphous polyester resin: | 4.5 mass parts |

(Polycondensation product of Bisphenol A propylene oxide adduct and isophthalic acid, glass transition temperature=65° C., number average molecular weight (Mn)=17000, a ratio of weight average molecular weight (Mw)/number average molecular weight (Mn)=2.4)

| | |
|---|---|
| Aluminum salicylate (BONTRON E-88, made by | 1.0 mass part |
| Orient Chemical Industries Co. Ltd.): | |

The obtained polymerizable monomer composition was heated to 63° C., then 9 mass parts of ester wax mainly composed of stearyl stearate were added thereto, mixed and dissolved. To this mixture were added 3 mass parts of 2,2′-azobis-2-methylbutyronitrile (as a polymerization initiator) and dissolved to obtain a polymerizable monomer mixture.

The polymerizable monomer mixture obtained above was added to the aqueous medium and stirred for 7 minutes at 10,000 rpm in a TK Homomixer under N₂ atmosphere at 63° C. so as to granulate the content. Thereafter, the mixture was reacted at 63° C. for 6 hours while stirring the mixture with a paddle stirring blade. Thereafter, the liquid temperature was set to 80° C., and stirring was continued for further 4 hours. After completion of the reaction, the reaction mixture was cooled, and hydrochloric acid was added to the suspension cooled to room temperature (25° C.) to dissolve the calcium phosphate salt, followed by filtration and washing with water to obtain wet toner particles. Next, the toner particles were dried at 40° C. for 12 hours to obtain clear toner mother particles having a volume-based median diameter of 7.6 μm and an average circularity of 0.971. 100 mass parts of the these toner mother particles and 0.7 mass parts of a hydrophobic silica fine powder treated with silicone oil having a BET value of 200 m²/g and an average primary particle diameter of 12 nm were mixed with a Henschel mixer (manufactured by Nippon Coke & Engineering Co., Ltd.) to obtain a clear toner 1. The storage elastic modulus G1′ of the clear toner 1 at 90° C. was 7.50×10⁵ dyn/cm².

### <Preparation of Clear Toner Developer 1>

A ferrite carrier (ferrite carrier with volume-based median diameter=30 μm) coated with a copolymer resin of cyclohexyl methacrylate and methyl methacrylate (monomer mass ratio=1:1) was added to the clear toner 1 so that the toner content in the developer became 6 mass %. The composite was mixed, and a clear toner developer 1 was prepared.

### (Fixing Device)

The effect of the present invention was evaluated using the same fixing device as in Example 1.

### Examples 9 to 13 and Comparative Examples 8 to 12

For each of Examples 9 to 13 and Comparative Examples 8 to 12 in which a white toner, a clear toner and a color toner other than a white were combined as indicated in the following Table IV, change in gloss was evaluated as described below.

### [Evaluation Method]

### <Change in Gloss>

For the two-component developers of Examples and Comparative Examples, glossy paper “POD Gloss Coat 128 (128 g/m²) (Oji Paper Co., Ltd.)” was used by employing the image forming apparatus and the fixing apparatus illustrated in FIG. 1 and FIG. 2. With a white toner in an adhesion amount listed in Table IV, with a cyan toner in an adhesion amount listed in Table IV, and with a clear toner in an adhesion amount listed in Table IV, images were formed in order of white, cyan, and clear toner in order from the paper. The formed image was thermally fixed with conditions of a nip width of 11.2 mm, a fixing time of 34 msec, a fixing pressure of 133 kPa, a system speed of 230 mm/sec, and a fixing temperature of 150° C. In other words, the color toner other than the white toner, the white toner, and the clear toner were thermally fixed at the same time.

1000 sheets were outputted under the above evaluation condition (this process is called as “output operation 1”). Thereafter, glossy paper “POD Gloss Coat 128 (128 g/m²) (Oji Paper Co., Ltd.)” was used to form an image on the paper with a white toner adhesion amount of 8 g/m². The formed image was thermally fixed with conditions of a nip width of 11.2 mm, a fixing time of 34 msec, a fixing pressure of 133 kPa, a system speed of 230 mm/sec, and a fixing temperature of 150° C. The gloss change was visually evaluated by comparing this image with the white image (reference white image) outputted under the same conditions before the output operation 1 by visual observation. If the clear toner remains on the fixing roller after the output operation 1, it should be recognized as a difference in gloss (change in gloss).

Evaluation criteria are as follows. The image having rank of ⊚ or ∘ is considered to be acceptable for practical use. The evaluation results are indicated in Table IV.

[Evaluation Criteria]

⊚: There is no difference in gloss between the reference white image and the sample.

◯: The sample gives slightly different glossy feeling compared with the reference white image, but there is no problems for practical use.

Δ: The sample is recognized to have clearly different glossy feeling.

X: The sample is recognized as having completely different glossy feeling.

TABLE IV

| | | | | | | | Fixing | | |
|---|---|---|---|---|---|---|---|---|---|
| | | | | | | | constitution | | |
| | | | | | | | Cleaning | | |
| | Toner constitution | | | | | | rotating | | |
| | Clear toner | | Cyan toner | | White toner | | roller, | | Evaluation |
| | | Adhesion | | Adhesion | | Adhesion | Present | | Change |
| | | amount | | amount | | amount | or | Cleaning | in |
| | Kind | (g/m²) | Kind | (g/m²) | Kind | (g/m²) | Absent | member | gloss |
| Example 9 | Clear | 8.0 | Cyan | 8.0 | White | 8.0 | Present | Present | ⊚ |
| | toner 1 | | toner 1 | | toner 1 | | | (for | |
| | | | | | | | | cleaning | |
| | | | | | | | | rotating | |
| | | | | | | | | roller) | |
| Example 10 | Clear | 8.0 | Cyan | 8.0 | White | 8.0 | Present | Present | ⊚ |
| | toner 1 | | toner 2 | | toner 1 | | | (for | |
| | | | | | | | | cleaning | |
| | | | | | | | | rotating | |
| | | | | | | | | roller) | |
| Example 11 | Clear | 8.0 | Cyan | 8.0 | White | 8.0 | Present | Present | ⊚ |
| | toner 1 | | toner 3 | | toner 1 | | | (for | |
| | | | | | | | | cleaning | |
| | | | | | | | | rotating | |
| | | | | | | | | roller) | |
| Example 12 | Clear | 5.0 | Cyan | 8.0 | White | 15.0 | Present | Present | ⊚ |
| | toner 1 | | toner 1 | | toner 1 | | | (for | |
| | | | | | | | | cleaning | |
| | | | | | | | | rotating | |
| | | | | | | | | roller) | |
| Example 13 | Clear | 8.0 | Cyan | 8.0 | White | 8.0 | Present | Present | ⊚ |
| | toner 1 | | toner 5 | | toner 1 | | | (for | |
| | | | | | | | | cleaning | |
| | | | | | | | | rotating | |
| | | | | | | | | roller) | |
| Comparative | Clear | 8.0 | Cyan | 8.0 | White | 8.0 | Absent | Absent | X |
| example 8 | toner 1 | | toner 1 | | toner 1 | | | | |
| Comparative | Clear | 8.0 | Cyan | 8.0 | White | 8.0 | Present | Present | X |
| example 9 | toner 1 | | toner 6 | | toner 1 | | | (for | |
| | | | | | | | | cleaning | |
| | | | | | | | | rotating | |
| | | | | | | | | roller) | |
| Comparative | Clear | 5.0 | Cyan | 5.0 | White | 5.0 | Present | Present | X |
| example 10 | toner 1 | | toner 1 | | toner 1 | | | (for | |
| | | | | | | | | cleaning | |
| | | | | | | | | rotating | |
| | | | | | | | | roller) | |
| Comparative | Clear | 15.0 | Cyan | 15.0 | White | 15.0 | Present | Present | X |
| example 11 | toner 1 | | toner 1 | | toner 1 | | | (for | |
| | | | | | | | | cleaning | |
| | | | | | | | | rotating | |
| | | | | | | | | roller) | |
| Comparative | Clear | 8.0 | Cyan | 8.0 | White | 8.0 | Absent | Present | X |
| example 12 | toner 1 | | toner 1 | | toner 1 | | | (for | |
| | | | | | | | | fixing | |
| | | | | | | | | rotating | |
| | | | | | | | | roller) | |

As can be seen from the evaluation results indicated in Table IV, the examples according to the present invention have almost no change in gloss, and they are far superior to the comparative examples.

What is claimed is:

1. An electrophotographic image forming method using two or more electrostatic image developing toners comprising a charging step, an exposing step, a developing step, a transferring step, and a fixing step,
wherein, among the two or more electrostatic image developing toners, at least one is an achromatic color toner or a clear toner, and at least one is a chromatic color toner which contains a crystalline resin and a releasing agent,
in the fixing step, a recording material to which is transferred an unfixed image formed with the two or more electrostatic image developing toners is nipped and conveyed to a fixing nip portion provided between a heated fixing rotating body and a pressurizing member, and thermally fixed,
in the fixing step, a residual toner component is cleaned by a cleaning rotating body which is in contact with the fixing rotating body and a cleaning member which is in contact with the cleaning rotating body.

2. The electrophotographic image forming method described in claim 1, wherein the achromatic color toner is a white toner.

3. The electrophotographic image forming method described in claim 1, wherein the achromatic color toner is a gray toner.

4. The electrophotographic image forming method described in claim 2, wherein the white toner contains titanium oxide as a white colorant.

5. The electrophotographic image forming method described in claim 4, wherein the white toner contains titanium oxide in the range of 10 to 70 mass %.

6. The electrophotographic image forming method described in claim 4, wherein the titanium oxide is a rutile type titanium oxide.

7. The electrophotographic image forming method described in claim 4, wherein the titanium oxide is an anatase type

8. The electrophotographic image forming method described in claim 1, wherein the chromatic color toner is any one of a cyan toner, a magenta toner and a yellow toner.

9. The electrophotographic image forming method described in claim 1, wherein the releasing agent contained in the chromatic color toner includes an ester wax or a hydrocarbon wax as a main component.

10. The electrophotographic image forming method described in claim 1, wherein a total amount of the toner on the recording material in the fixing step is in the range of 8 to 30 g/m².

11. The electrophotographic image forming method described in claim 1, wherein the cleaning rotating body is a cleaning rotating roller.

12. The electrophotographic image forming method described in claim 1, wherein the cleaning member is a nonwoven fabric containing at least one of an aromatic polyamide fiber and a polyester fiber.

13. The electrophotographic image forming method described in a claim 1,
wherein the cleaning member is a nonwoven fabric containing an aromatic polyamide fiber and a polyester fiber, and
a mass ratio (PA:PE) of the aromatic polyamide fiber (PA) to the polyester fiber (PE) is in the range of 9:1 to 1:9.

14. The electrophotographic image forming method described in claim 1, wherein the cleaning member is wound up in an amount 0.1 μm to 1 mm per one sheet of A4 size paper.

15. The electrophotographic image forming method described in claim 1, wherein the cleaning member is not impregnated with a silicone oil.

16. The electrophotographic image forming method described in claim 1, wherein the crystalline resin contains a crystalline polyester resin.

17. The electrophotographic image forming method described in claim 1, wherein the crystalline resin contains a hybrid crystalline polyester resin in which a crystalline polyester polymerization segment and an amorphous polymerization segment are chemically bonded.
